(19) United States
(12) Patent Application Publication
(10) Pub. No.: US 2026/0128389 A1
(43) Pub. Date: May 7, 2026

(54) NANOWIRE COMPOSITIONS AND METHODS THEREOF

(71) Applicants: Sila Nanotechnologies, Inc., Alameda, CA (US); Georgia Tech Research Corporation, Atlanta, GA (US)

(72) Inventors: Wenbin FU, Atlanta, GA (US); Kaixi CHEN, Atlanta, GA (US); Fujia WANG, Santa Clara, CA (US); Gleb Nikolayevich YUSHIN, Atlanta, GA (US)

(21) Appl. No.: 18/955,724

(22) Filed: Nov. 21, 2024

Related U.S. Application Data
(60) Provisional application No. 63/601,464, filed on Nov. 21, 2023.

(51) Int. Cl. H01M 10/42; C01F 7/50; D01F 9/08; D01F 11/00; D04H 1/4209; D04H 1/4382; H01M 4/66; H01M 10/0525; H01M 10/0568

(52) U.S. Cl. CPC H01M 10/4235; C01F 7/50; D01F 9/08; D01F 11/00; D04H 1/4209; D04H 1/43838; H01M 4/661; H01M 10/0525; H01M 10/0568; C01P 2002/72; C01P 2002/85; C01P 2004/03; C01P 2004/04; C01P 2006/40; D10B 2101/10; D10B 2505/00; H01M 2300/0025

(57) ABSTRACT

Disclosed is a nanowire composition that includes nanowires comprising aluminum fluoride (AlF₃) (AFNWs). The aluminum fluoride comprises α-phase AlF₃. In some implementations, an average diameter of the AFNWs is in a range of 100 to 500 nm, an average length of the AFNWs is in a range of 100 to 1000 μm, and an average aspect ratio of the AFNWs is in a range of 1000 to 1×10⁴. An AFNW membrane, an anode-interlayer component comprising AFNWs, and a lithium metal battery incorporating the anode-interlayer component are also disclosed. Related methods of making AFNWs, an AFNW membrane, an anode-interlayer component, and a lithium metal battery are also disclosed.

### CROSS-REFERENCE TO RELATED APPLICATIONS

The present application for patent claims the benefit of U.S. Provisional Application No. 63/601,464, entitled “FREE-STANDING CONVERSION INTERLAYER FOR STABLE LITHIUM METAL BATTERIES,” filed Nov. 21, 2023, assigned to the assignees hereof, and expressly incorporated herein by reference in its entirety.

### BACKGROUND

### Field

Aspects of the present disclosure relate generally to energy storage devices and, more particularly, to battery technology and the like. Aspects of the present disclosure relate to nanowire membranes and their use as a conversion interlayer in an anode-interlayer component for a battery, a supercapacitor or another energy storage device. Aspects of the present disclosure relate to methods of making a nanowire membrane.

### Background

Owing in part to their relatively high energy densities, specific energy, light weight, and potential for long lifetimes, advanced rechargeable metal batteries and metal-ion batteries, such as lithium-ion (Li-ion) batteries, are desirable for a wide range of consumer electronics, electric vehicle, grid storage and other important applications. However, despite their widespread use, current Li-ion batteries face limitations that hinder their performance in demanding applications. For instance, as the specific energy of commercial Li-ion batteries reaches ˜250 Wh kg⁻¹, battery-powered electric cars are mostly capable of achieving a driving range of about 150-300 miles (about 240-480 km), which adequately meets general usage needs but falls short for long trips or challenging weather. One major hurdle lies in the low specific capacity of traditional electrode materials, including graphite anodes with a theoretical capacity of 372 mAh g⁻¹, due to the inherent limitations of intercalation chemistry. This constraint not only limits the energy density of Li-ion batteries but also their ability to meet the increasing demands for higher performance in electric transportation and energy storage systems.

Utilizing lithium (Li) metal as the anode in Li-ion batteries offers a promising pathway to address these limitations. Among all known anode materials, lithium metal has the highest theoretical specific capacity of 3860 mAh g⁻¹, which is significantly greater than that of graphite. Additionally, its low reduction potential of −3.04 V versus the standard hydrogen electrode makes it an ideal candidate for achieving high energy densities. The use of lithium metal anodes could enable energy densities of up to 400-500 Wh kg⁻¹, representing a significant leap compared to current commercial Li-ion batteries. Such advancements would dramatically extend the driving range of electric vehicles, potentially alleviating range anxiety, while also reducing the size and weight of batteries for portable electronics and making high-demand applications such as electric aviation and grid-scale energy storage more feasible.

Despite its advantages, using lithium (Li) metal as an anode in rechargeable Li-ion batteries presents significant technical challenges, primarily due to the formation of lithium dendrites and instability of the solid-electrolyte interphase (SEI). During repeated charge and discharge cycles, lithium metal tends to form needle-like dendrites that grow uncontrollably from the anode surface. These dendrites can eventually pierce the separator between the anode and cathode, leading to internal short circuits and thermal runaway. Additionally, the continual growth of dendrites causes the SEI, which is a protective layer that forms on the anode, to crack and reform with each cycle, leading to increased electrolyte decomposition and the formation of “dead” or inactive lithium. This degradation of the SEI layer and accumulation of inactive lithium significantly reduces the battery's lifespan, energy efficiency, and safety, making it challenging to harness the full potential of Li metal in practical, long-lasting rechargeable batteries.

Extensive efforts have been directed toward stabilizing the lithium metal anode and its interphase using strategies such as advanced liquid electrolytes, additives, solid-state electrolytes (SSEs), lithophilic current collectors or hosts, optimized nucleation potentials and currents, and protective interlayers on the lithium surface or separator. These approaches primarily aim to form a stable in-situ artificial interphase that guides lithium nucleation, suppresses dendrite growth, and stabilizes the SET. For example, solid-state electrolytes (SSEs) can physically block lithium dendrite growth, while certain additives in liquid electrolytes can enhance the stability of the SEI layer, reducing the risk of dendrite formation. Protective interlayers made of ceramic oxides or functionalized coatings have also shown promise in promoting uniform lithium deposition, thereby minimizing dendrite growth. However, each of these approaches has notable limitations. For example, advanced liquid electrolytes are prone to inflammability and thermal instability, and their long-term performance is limited by decomposition under high-voltage or cycling conditions. Additives are often limited by their concentration dependency, which can negatively affect ionic conductivity and long-term compatibility with diverse cathode materials. SSEs suffer from high interfacial resistance, mechanical brittleness, and difficulties in maintaining stable interfaces with the lithium metal anode during cycling. Protective coatings or interlayers can mechanically suppress dendrites and stabilize the SEI. However, many of these materials lack thermal and chemical stability under realistic operating conditions. Prolonged cycling often leads to interfacial degradation, while synthesis processes for these interlayers are typically costly and environmentally unfriendly.

Despite advancements in mitigating the challenges of lithium metal anodes, additional advancements are desired to make this technology commercially viable. An important aspect is the development of materials and interfaces that offer long-term stability, robust dendrite suppression, and durability over many charge cycles, all without limiting energy density. Additionally, there is a desire for scalable, cost-effective manufacturing techniques to produce advanced materials and components at commercial volumes. Improved safety is also desired, such as making lithium metal batteries more resilient to mechanical stresses, temperature fluctuations, and other environmental conditions. Furthermore, it is preferable that these batteries are compatible with existing manufacturing processes and can be produced with minimal environmental impact.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a nanowire composition includes nanowires comprising aluminum fluoride (AlF₃).

In some aspects, the AlF₃ comprises α-phase AlF₃.

In some aspects, the nanowires are porous and comprise external pores.

In some aspects, an average diameter of the nanowires is in a range of about 100 to about 500 nm.

In some aspects, an average length of the nanowires is in a range of about 100 to about 1000 μm.

In some aspects, an average aspect ratio of the nanowires is in a range of about 1000 to 1×10⁴.

In an aspect, a membrane includes a nanowire composition.

In some aspects, the membrane comprises a nonwoven network of the nanowires.

In an aspect, an anode-interlayer component includes an anode; and an interlayer disposed on the anode, wherein: the interlayer comprises a nanowire composition; and the interlayer is in the form of a membrane or a coating.

In some aspects, the anode comprises one or more of the following in direct contact with the interlayer: Li metal, a current collector, or composite particles comprising carbon and silicon.

In some aspects, the anode comprises the current collector; and the current collector comprises Cu, Al, Ni, Ti, Mo, Fe, steel, a graphene coating, a carbon coating or film, carbon nanotubes, and/or carbon nanofibers.

In an aspect, a lithium-ion battery includes a cathode; an anode-interlayer component; and an electrolyte ionically coupling the cathode and the anode-interlayer component, wherein: the interlayer faces toward the cathode.

In some aspects, the cathode comprises lithium iron phosphate (LFP), lithium nickel manganese cobalt oxide, lithium cobalt oxide, lithium nickel cobalt aluminum oxide, and/or lithium manganese oxide.

In some aspects, a separator disposed between the interlayer and the cathode,

In some aspects, the electrolyte comprises LiPF₆, lithium bis(trifluoromethanesulfonyl)imide (LiTFSI), and/or lithium bis(fluorosulfonyl)imide (LiFSI).

In some aspects, the current collector comprises Cu; and the anode comprises Li nuclei particles located between the current collector and the interlayer.

In some aspects, at least some of the Li nuclei particles are fused together; and the anode comprises a porous layer comprising the fused Li nuclei particles.

In some aspects, the porous layer has a thickness in a range of about 1 to about 12 μm.

In some aspects, the current collector comprises a Li metal layer; and the Li metal layer is free of dendrites after cycling of the lithium-ion battery.

In an aspect, a method includes (A1) dealloying an Al—Li alloy in an alcohol to form a dispersion of Al alkoxide nanowires in a solvent comprising the alcohol; (A2) filtrating the Al alkoxide nanowires to remove the solvent; (A3) annealing the filtrated Al alkoxide nanowires to convert the filtrated Al alkoxide nanowires to Al₂O₃ nanowires; and (A4) carrying out a fluorination treatment to convert the Al₂O₃ nanowires to nanowires comprising aluminum fluoride (AlF₃).

In some aspects, the AlF₃ comprises α-phase AlF₃.

In some aspects, the alcohol comprises methanol, ethanol, propanol, or butanol.

In some aspects, the filtrating is carried out under vacuum.

In some aspects, the annealing is carried out in a temperature range of about 300 to about 600° C.

In some aspects, the fluorination treatment is carried out with a fluorinating gas selected from: nitrogen trifluoride (NF₃) gas, hydrogen fluoride (HF) gas, fluorine (F₂) gas, chlorine trifluoride (ClF₃) gas, sulfur hexafluoride (SF₆) gas, and chlorodifluoromethane (CHClF₂) gas.

In some aspects, the filtrated Al alkoxide nanowires are in the form of a membrane upon removal of the solvent.

In some aspects, the membrane comprises the filtrated AlF₃-comprising nanowires upon completion of the annealing (A4).

In some aspects, the membrane is configured as an interlayer disposed on an anode; the anode comprises one or more of the following in direct contact with the interlayer: Li metal, a current collector, or composite particles comprising carbon and silicon; and the interlayer and the anode together constitute an anode-interlayer component.

In some aspects, (A5) making a slurry comprising the AlF₃-comprising nanowires; and (A6) dispensing the slurry on a substrate to form a coating comprising the AlF₃-comprising nanowires disposed on the substrate.

In some aspects, the method includes carrying out milling on the AlF₃-comprising nanowires before making the slurry.

In some aspects, the substrate comprises an anode; the coating is an interlayer comprising the AlF₃-comprising nanowires; the anode comprises one or more of the following in direct contact with the interlayer: Li metal, a current collector, or composite particles comprising carbon and silicon; and the interlayer and the anode together constitute an anode-interlayer component.

Other objects and advantages associated with the aspects disclosed herein will be apparent to those skilled in the art based on the accompanying drawings and detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example metal-ion (e.g., Li-ion) battery (including those in which the anode is a metal (e.g., Li or Li alloy)) in which the components, materials, processes, and other techniques described herein, or combinations thereof, may be implemented according to various embodiments.

FIG. 2A shows a flow diagram of a process of making a Li-ion battery (with anodes formed by dispensing an anode slurry) according to one aspect.

FIG. 2B shows a flow diagram of a process of making a Li-ion battery (with a Li metal employed as an anode) according to one aspect.

FIG. 3 shows a flow diagram of a process of making a separator coating in one aspect.

FIG. 4 shows a flow diagram of a process of sequentially forming an electrode coating and a separator coating to obtain an integrated electrode-separator component in one aspect.

FIG. 5 shows a flow diagram of a process of making an AlF₃ nanowire (AFNW) composition in one aspect.

FIG. 6A schematically illustrates a synthesis process for an AFNW membrane in one aspect.

FIG. 6B schematically illustrates Li deposition on a current collector of Cu with and without an AFNW membrane.

FIG. 7A shows a scanning electron microscope (SEM) image of a sample AFNW membrane. The inset shows a photograph of sample AFNW membranes after cutting into discs.

FIG. 7B shows an SEM image of a sample AFNW membrane, at a higher magnification than in FIG. 7A. The inset shows a cross-sectional view SEM image of a sample AFNW membrane.

FIG. 7C shows a transmission electron microscopy (TEM) image of an individual AFNW. The Inset shows a high-resolution TEM image of the individual AFNW.

FIG. 7D shows energy dispersive x-ray spectroscopy (EDS) elemental maps of an individual AFNW.

FIG. 7E shows an X-ray diffraction (XRD) spectrum of sample AFNWs.

FIG. 7F shows a high-resolution X-ray photoelectron spectroscopy (XPS) spectrum of the F is signal of sample AFNWs.

FIG. 7G shows a high-resolution XPS spectrum of the Al 2p signal of sample AFNWs.

FIG. 8 shows EDS elemental maps and spectrum of a sample AFNW membrane.

FIG. 9 shows an XRD spectrum of an AFNW membrane after initial lithiation (after being discharged to 0.05 V and held for 20 h).

FIG. 10A shows SEM images of Li nuclei on Cu current collector with and without an AFNW membrane in respective electrolytes.

FIG. 10B schematically shows Li nuclei on Cu current collector with and without an AFNW membrane in respective electrolytes.

FIG. 11 shows XPS spectra of C 1s, F 1s, and Li is signals on the surface of Li nuclei deposited on Cu current collector with and without an AFNW membrane in Lithium∥Copper (Li∥Cu) cells.

FIG. 12A shows SEM images of Li deposited on Cu current collector with and without an AFNW membrane for a capacity of 1 mA h cm⁻² at respective current densities.

FIG. 12B shows EDS elemental maps of Li deposited on Cu current collector with an AFNW membrane.

FIG. 12C shows focused ion beam scanning electron microscopy (FIB-SEM) images of Li plated on Cu current collector with and without an AFNW membrane at a current density of 1 mA cm⁻² for a capacity of 1 mAh cm⁻².

FIG. 12D schematically shows the morphology of deposited Li on Cu current collector with and without an AFNW membrane.

FIG. 13A shows a comparison of Coulombic Efficiency (CE) of Li∥Cu cells with and without an AFNW membrane at respective current densities for a fixed capacity of 1 mAh cm⁻².

FIG. 13B shows voltage profiles of Li∥Cu cells with an AFNW membrane at a current density of 1 mA cm⁻² at respective cycles.

FIG. 13C shows voltage profiles of Li∥Cu cells with bare Cu at a current density of 1 mA cm⁻² at respective cycles.

FIG. 13D shows average coulombic efficiencies (CEs) of Li∥Cu cells with and without an AFNW membrane.

FIG. 13E shows Li plating/stripping performance in Li∥Li symmetric cells with and without an AFNW membrane.

FIG. 14A shows a comparison of nucleation overpotentials of Li∥Cu cells with and without an AFNW membrane at a current density of 0.5 mA cm⁻² in 1 M LiTFSI/DME/DOL+1 wt. % LiNO₃ electrolyte. LiTFSI is lithium bis(trifluoromethanesulfonyl) imide, DME is 1,2-dimethoxyethane, and DOL is dioxolane.

FIG. 14B shows a comparison of nucleation overpotentials of Li∥Cu cells with and without an AFNW membrane at a current density of 1 mA cm⁻² in 1 M LiTFSI/DME/DOL+1 wt. % LiNO₃ electrolyte.

FIG. 15A shows cycle stability of Li∥Cu cells with and without an AFNW membrane in 1 M LiPF₆/EC/DEC electrolyte (current density of 1 mA cm⁻², areal capacity of 1 mAh cm⁻²). EC is ethylene carbonate; DEC is diethyl carbonate.

FIG. 15B shows a comparison of overpotentials of Li∥Cu cells with and without an AFNW membrane during initial cycles.

FIG. 16 shows cycle stability of Li∥Cu cells with and without an AFNW membrane in 1.5 M LiFSI/DME/TTE electrolyte (current density of 1 mA cm⁻², areal capacity of 1 mAh cm⁻²). LiFSI is lithium bis(fluorosulfonyl)imide, DME is 1,2-dimethoxyethane, and TTE is 1,1,2,2-tetrafluoroethyl 2,2,3,3-tetrafluoropropyl ether.

FIG. 17A shows cycle stability of Li∥LFP cells with and without an AFNW membrane in 1 M LiTFSI/DME/DOL electrolyte at a charge/discharge rate of 0.5 C (first 2 cycles at 0.1 C). LiTFSI is lithium bis(trifluoromethanesulfonyl) imide and DOL is dioxolane.

FIG. 17B shows charge-discharge voltage profiles of Li∥LFP cells with an AFNW membrane at different charge/discharge rates (C-rate in a range of 0.1 C-3 C).

FIG. 17C shows cycle stability of Li∥NCM811 cells with and without an AFNW membrane in 1.5 M LiFSI/DME/TTE electrolyte at 0.5 C (first 2 cycles at 0.1 C). NCM811 has an approximately composition of LiNi_{0.8}Co_{0.1}Mn_{0.1}O₂.

FIG. 17D shows charge-discharge voltage profiles of NCM811 cells with an AFNW membrane at respective cycles.

FIG. 17E shows cycle stability of Cu∥NCM811 cells with and without an AFNW membrane in 1.5 M LiFSI/DME/TTE at a charge/discharge rate of 0.2 C and a discharge rate of 0.5 C.

FIG. 17F shows voltage profiles of Cu∥NCM811 cells with and without an AFNW membrane at respective cycles.

FIG. 18A shows voltage profiles of Li∥LFP cells (N/P=3) with bare Cu at respective C-rates. LFP is LiFePO₄.

FIG. 18B shows a comparison of rate capability of Li∥LFP cells (N/P=3) with and without an AFNW membrane.

FIG. 19A shows cycle stability of Li∥LFP full cells with and without an AFNW membrane with N/P=2.

FIG. 19B shows cycle stability of Li∥LFP full cells with and without an AFNW membrane with N/P=1.

FIG. 20A shows voltage profiles of Li∥NCM811 cells (N/P=3) with bare Cu at 5^{th}, 10^{th}, 50^{th} and 100^{th} cycles.

FIG. 20B shows voltage hysteresis of NCM811 cells (N/P=3) with and without an AFNW membrane at 5^{th} and 100^{th} cycles.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details. Further, the terminology of “at least partially” is intended for interpretation as “partially, substantially or completely”.

While the description below may describe certain examples in the context of Li metal and Li-ion batteries (for brevity and convenience, and because of the current popularity of Li technology), it will be appreciated that various aspects may be applicable to other rechargeable and primary, metal and metal-ion batteries (such as Na metal and Na-ion, Mg metal and Mg-ion, K metal and K-ion, Ca metal and Ca-ion, Al metal and Al-ion, and others).

While the description below may also describe certain examples of the cathode material formulations either in a Li-free (e.g., charged) state or in a fully lithiated (e.g., discharged) state, it will be appreciated that various aspects may be applicable to various Li-containing electrodes (e.g., in either a partially or fully discharged state) or to essentially Li-free electrodes (e.g., in either a partially or fully charged state).

While the description below may describe certain examples in the context of LiF chemistry, it will be appreciated that various aspects may be applicable to other lithium halide chemistries (such as LiCl, for example) or other alkali halide chemistries (such as NaF or KF or NaCl, for example) or alkaline earth halide chemistries (such as CaF₂ or CaCl₂, for example).

While the description below may describe certain examples in the context of “pure” fluoride-based chemistry of active conversion-type cathode materials (e.g., LiF and Cu, LiF and Fe, LiF and Fe—Cu, FeF₃, CuF₂, NiF₂, BiF₃, MnF₃, Cu—Fe—F₂₋₃, Cu—Fe—Mn—F₂₋₃, Cu—Fe—Ni—F₂₋₃, Cu—Bi—F₂₋₃, Cu—Fe—Bi—F₂₋₃ and many other “pure” metal fluoride-based chemistries and their mixtures), it will be appreciated that various aspects may be applicable to metal oxyfluorides/oxy-fluorides (e.g., Cu—O—F, Fe—O—F, Fe—Cu—O—F, Cu—Li—O—F, Fe—Li—O—F, Fe—Cu—Li—O—F, Fe—Cu—Mn—Li—O—F, Fe—Cu—Ni—Li—O—F, Fe—Cu—Bi—Li—O—F, and other compositions comprising mixed F and O anions), metal chloro-fluorides (e.g., Cu—Cl—F, Fe—Cl—F, Fe—Cu—Cl—F, Cu—Li—Cl—F, Fe—Li—Cl—F, Fe—Cu—Li—Cl—F, Fe—Cu—Mn—Li—Cl—F, Fe—Cu—Ni—Li—Cl—F, Fe—Cu—Bi—Li—Cl—F, and various other compositions comprising mixed F and Cl anions), metal bromo-fluorides (various compositions comprising mixed F and Br anions), metal oxy-chloro-fluorides (various compositions comprising mixed F, Cl and O anions), metal oxy-bromo-fluorides (various compositions comprising mixed F, Br and O anions), metal sulfo-fluorides (various compositions comprising mixed F and S anions), metal sulfo-oxy-fluorides (various compositions comprising mixed F, O and S anions), their various mixtures, alloys and other combinations and other mixed anions' comprising conversion-type cathode compositions where the atomic ratio of all the present nonmetals (e.g., O, S, Cl, Se and/or others) to F in the cathode material composition (e.g., the atomic ratio of O:F or the atomic ratio of (O and Cl and S and Se):F, etc.) may range from around 10-20 to around 7-10⁻¹.

While the description below may describe certain examples in the context of Li storage in the cathodes based on the transition metal (such as Cu, Fe, Mn, Ni, Bi, etc.) reduction-oxidation (redox) reactions, it will be appreciated that various aspects may be applicable to materials where a portion of Li storage relies on the anion (such as oxygen, 0, etc.) redox reactions in the cathodes. Examples of such materials may include various conversion-type or intercalation-type or mixed-type cathode active materials that comprise both fluorine and at least one non-fluorine electronegative element that may exhibit multiple oxidation states, such as oxygen. In some designs, other (more rare) illustrative examples of such materials include those that in addition to metal(s) and fluorine also comprise sulfur or chlorine or other multivalent anions and their various combinations, etc.

While the description below may describe certain examples in the context of Li storage in the cathodes in the potential range from around 1.5 V to around 4-4.2V vs. Li/Li⁺, it will be appreciated that various aspects may be applicable to reversible Li storage in the potentials above around 4V vs. Li/Li⁺ (e.g., up to around 5.4 V vs. Li/Li⁺) or to reversible Li storage in the potentials below around 1.5V vs. Li/Li⁺ (e.g., down to around 0.5V vs. Li/Li⁺) or both. Also, it will be appreciated that the lower range of the potentials may be higher than around 1.5 V vs. Li/Li⁺ and the higher range of potentials may be lower than around 4.0 V vs. Li/Li⁺.

While the description below may describe certain examples in the context of “pure” conversion-type chemistry of active cathode materials, it will be appreciated that various aspects may be applicable to mixed intercalation/conversion type active materials where both intercalation and conversion mechanisms of Li ion storage may take place during battery cell operation. Furthermore, in some designs, primarily (e.g., between about 50-100%) intercalation-type mechanism(s) of Li ion storage may take place during some range of the cell charge or discharge (as an illustrative but not limited example, from around 0.0% to around 40.0% of the full discharge capacity). Similarly, in some designs, primarily (e.g., between about 50-100%) conversion-type mechanism(s) of Li ion storage may take place during some range of the cell charge or discharge (as an illustrative but not limited example, from around 0.5% to around 100.0% of the full discharge capacity).

While the description below may describe certain examples in the context of fluoride-based chemistry of active conversion-type cathode materials (e.g., LiF and Cu, LiF and Fe, LiF and Fe—Cu, FeF₃, CuF₂, BiF₃, NiF₂, Cu—Fe—F₂₋₃ and other fluoride-based chemistries), it will be appreciated that various aspects may be applicable to lithium chalcogenide (e.g., Li₂S or Li₂Se or Li₂—S—Se, etc.) based, metal oxyfluoride-based and other types of chemistries of conversion-type (including a displacement-type and a chemical transformation-type) active cathode (or anode, including Si-comprising or Si-based) materials.

While the description below may describe certain examples of Li metal and Li-ion batteries with a combination of conversion-type metal fluoride cathode materials and specific liquid electrolytes, it will be appreciated that various aspects may be applicable to battery cells comprising various solid and/or semisolid electrolytes, including but not limited to various gel polymer electrolytes, various solid polymer electrolytes (including those where anions are chemically linked to the polymer backbone), various ceramic electrolytes, various glass-ceramic electrolytes, various glass-liquid composite electrolytes, various ceramic-liquid composite electrolytes, various glass electrolytes, various other composite and nanocomposite solid electrolytes (e.g., those that comprise both polymer and inorganic (nano)materials), among others.

While the description below may describe certain examples in the context of particular electrode or electrode particle chemistry, composition, architecture and morphology, certain examples in the context of particular or electrode particle synthesis stages, certain examples in the context of particular electrolyte composition, certain examples in the context of particular electrolyte incorporation into an electrode or a battery cell, it will be appreciated that various aspects may be applicable to battery cells that advantageously incorporate a combination of some of the described electrode chemistries, composition, architecture as well as electrolyte composition and electrode or cell manufacturing methods.

While the description below may describe certain examples in the context of metal fluoride-based electrode chemistry, it will be appreciated that various aspects may be applicable to other types of cathodes as well as various types of anodes (e.g., silicon (Si)-comprising anodes), including various alloying-type anodes (including Li metal anode), conversion-type cathodes and anodes, intercalation-type and mixed type cathodes and anodes. Furthermore, various electrolyte-related aspects of the description may be related to full cells, where electrolyte may be incorporated into the anode, cathode and/or the separator. In various aspects of the disclosure, alloying-type electrodes (e.g., anodes or cathodes) are considered to be a sub-class of conversion-type electrodes.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| Material | Property | Measurement | |
|---|---|---|---|
| Type | Type | Instrumentation | Measurement Technique |
| Active | Coulombic | Potentiostat | Charge (current) is passed to |
| Material | Efficiency | | an electrode containing the |
| | | | active material of interest |
| | | | until a given voltage limit is |
| | | | reached. Then, the current is |
| | | | reversed (discharge current) |
| | | | until a second voltage limit is |
| | | | reached. The ratio of the two |
| | | | charges passed determines |
| | | | the Coulombic Efficiency |
| | | | (CE). In the simplest case, |
| | | | the charge and discharge |
| | | | currents may be constant |
| | | | and often have absolute |
| | | | values that are the same or |
| | | | close to each other. It should |
| | | | be understood though that in |
| | | | some experiments, either |
| | | | charge current or discharge |
| | | | current or both may be |
| | | | changing during such |
| | | | experiments (e.g., be initially |
| | | | constant and when the |
| | | | voltage limit is reached, |
| | | | diminishing to a |
| | | | predetermined value). In |
| | | | addition, the absolute value |
| | | | of the charge and discharge |
| | | | currents may differ. |
| Active | Partial | Manometer | The partial vapor pressure |
| Material | Vapor | | of an active material in a |
| | Pressure | | mixture (e.g., composite |
| | (e.g., Torr.) | | particle) at a particular |
| | at a | | temperature is given by the |
| | Temperature | | known vapor pressure of the |
| | (e.g., K) | | active material multiplied by |
| | | | its mole fraction in the |
| | | | mixture. |
| Active | Volume | Gas pycnometer | Gas pycnometer measures |
| Material | | | the skeletal volume of a |
| Particle | | | material by gas displacement |
| | | | using the volume-pressure |
| | | | relationship of Boyle's Law. |
| | | | A sample of known mass is |
| | | | placed into the sample |
| | | | chamber and maintained at |
| | | | a constant temperature. An |
| | | | inert gas, typically helium, is |
| | | | used as the displacement |
| | | | medium. |
| | | | Note: A vol. % change may |
| | | | be calculated from two |
| | | | volume measurements of the |
| | | | active material particle. |
| Active | Open | nitrogen | Nitrogen sorption/desorption |
| Material | Internal | sorption/desorption | isotherm (typically at 77K) is |
| Particle | Pore Volume | isotherm | collected and analyzed to |
| | (e.g., cc/g or | | estimate the total amount of |
| | cm³/g) | | gas adsorbed/desorbed and |
| | | | internal pore volume of the |
| | | | sample with known mass is |
| | | | estimated from such |
| | | | measurements. Pore size |
| | | | distribution (PSD) may be |
| | | | further estimated from the |
| | | | sorption/desorption isotherm |
| | | | using various analyses, such |
| | | | as Non-Local Density |
| | | | Functional Theory (NLDFT) |
| Active | Volume- | PSA, scanning | PSA using laser scattering, |
| Material | Average Pore | electron microscope | electron microscopy (SEM, |
| Particle | Size and Pore | (SEM), transmission | TEM, STEM) in |
| | Size | electron microscope | combination with image |
| | Distributions | (TEM), scanning | analyses, laser microscopy |
| | (e.g., nm) | transmission | (for larger particles and |
| | | microscope (STEM), | larger pores) in combination |
| | | laser microscope, | with image analyses, optical |
| | | Synchrotron X-ray, | microscopy (for larger |
| | | X-ray microscope | particles and larger pores), |
| | | | neutron scattering, X-ray |
| | | | scattering, X-ray microscopy |
| | | | imaging may be employed to |
| | | | measure pore sizes (average |
| | | | pore size or pore size |
| | | | distribution) in different size |
| | | | ranges (in addition to the |
| | | | analysis of the |
| | | | sorption/desorption |
| | | | isotherms). |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas |
| | | | pycnometer and comparing |
| | | | them to the theoretical |
| | | | density of the individual |
| | | | material components present |
| | | | in Si-comprising particles. In |
| | | | addition, closed internal |
| | | | pore volume may be |
| | | | estimated by comparing the |
| | | | total pore volume estimated |
| | | | from neutron scattering and |
| | | | the nitrogen-accessible pore |
| | | | volume estimated from |
| | | | nitrogen sorption isotherms. |
| Active | Closed | Gas pycnometer | With a pycnometer, the |
| Material | Internal | | amount of a certain medium |
| Particle | Volume- | | (liquid or Helium or other |
| | Average Size | | analytical gases) displaced |
| | (e.g., nm) | | by a solid can be determined. |
| Active | Size | TEM, STEM, SEM, | Laser particle size |
| Material | (e.g., nm, μm, | X-Ray, PSA, etc. | distribution analysis (LPSA), |
| Particle | etc.) | | laser image analysis, electron |
| | | | microscopy, optical |
| | | | microscopy or other suitable |
| | | | techniques |
| | | | transmission electron |
| | | | microscopy (TEM), scanning |
| | | | transmission electron |
| | | | microscopy (STEM), |
| | | | scanning electron |
| | | | microscopy (SEM)), X-ray |
| | | | microscopy, X-ray |
| | | | diffraction, neutron |
| | | | scattering and other suitable |
| | | | techniques |
| Active | Composition | Balance | Note #1: A wt. % change |
| Material | (e.g., mass | | may be calculated by |
| Particle | fraction or | | comparing the mass fraction |
| | wt. %, mg, | | of a material in the particle |
| | number of | | relative to the total particle |
| | atoms, etc.) | | mass. |
| | | | Note #2: The capacity |
| | | | attributable to particular |
| | | | active material(s) in the |
| | | | particle may be derived from |
| | | | the composition, based on |
| | | | the known (e.g., theoretical |
| | | | or practically attainable) |
| | | | capacity(ies) of each active |
| | | | material. |
| | | | Note #3: The composition of |
| | | | the particle may be |
| | | | characterized in terms of |
| | | | weight (e.g., mg). The |
| | | | composition of may |
| | | | alternatively be |
| | | | characterized by a number |
| | | | of atoms of a particular |
| | | | element (e.g., Fe, F, C, etc.). |
| | | | In case of atoms, the number |
| | | | of atoms may be estimated |
| | | | from the weight of that atom |
| | | | in the particle (e.g., based on |
| | | | gas chromatography) |
| Active | Composition | X-ray Fluorescence | |
| Material | (e.g., mass | (XRF), Inductively | |
| Particle | fraction or | Coupled Plasma | |
| | wt. % of | Optical Emission | |
| | various | Spectroscopy (ICP- | |
| | atomic | OES); Energy | |
| | elements or | Dispersive | |
| | molecules, | Spectroscopy (EDS), | |
| | atomic | Wavelength | |
| | fraction or | Dispersive | |
| | at. % of | Spectroscopy | |
| | various | (WDS), Electron | |
| | elements, | Energy Loss | |
| | etc.) | Spectroscopy | |
| | | (EELS), Nuclear | |
| | | Magnetic Resonance | |
| | | (NMR); Secondary | |
| | | Ion Mass | |
| | | Spectrometry | |
| | | (SIMS); X-Ray | |
| | | Photoelectron | |
| | | Spectroscopy (XPS); | |
| | | Fourier Transform | |
| | | Infrared | |
| | | Spectroscopy (FTIR) | |
| | | and Raman | |
| | | Spectroscopy | |
| | | (Raman) | |
| Active | Specific | Potentiostat | An electrode containing an |
| Material | Capacity | | active anode or cathode |
| Particle, | | | material of interest is |
| Battery | | | charged or discharged (by |
| Half-Cell | | | passing electrical current to |
| | | | the electrode) within certain |
| | | | potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) |
| | | | gives this quantity (e.g., in |
| | | | mAh/g). The active mass is |
| | | | computed by multiplying the |
| | | | total mass of the electrode by |
| | | | the active material mass |
| | | | fraction. Both reversible and |
| | | | irreversible capacity during |
| | | | charge or discharge may be |
| | | | calculated in this way. |
| Active | BET SSA | BET instrument | A sample is placed into a |
| Material | (e.g., m²/g) | | sealed chamber at 77K, |
| Particle | | | where nitrogen is introduced |
| | | | at increasing pressure. The |
| | | | change in pressure of the |
| | | | nitrogen is used to calculate |
| | | | the surface area of the |
| | | | sample. |
| Active | Aspect Ratio | SEM, TEM | The dimensions and shape of |
| Material | | | the particles are typically |
| Particle | | | measured by using SEM or |
| | | | TEM or (for large particles) |
| | | | by using optical microscopy. |
| Active | True Density | Argon Gas | True density values may be |
| Material | of Particle | Pycnometer | measured by using an argon |
| Particle | (e.g., g/cc or | | gas pycnometer and |
| | g/cm³) | | comparing to the theoretical |
| | | | density of the individual |
| | | | material components present |
| | | | in the particle. |
| Active | Particle Size | Dynamic light | laser particle size |
| Material | Distribution | scattering particle | distribution analysis (LPSA) |
| Particle | (e.g., nm or | size analyzer, | on well-dispersed particle |
| Population | μm) | scanning electron | suspensions in one example |
| | | microscope | or by image analysis of |
| | | | electron microscopy images, |
| | | | or by other suitable |
| | | | techniques. While there are |
| | | | diverse processes of |
| | | | measuring PSDs, laser |
| | | | particle size distribution |
| | | | analysis (LPSA) is quite |
| | | | efficient for some |
| | | | applications. Note that other |
| | | | types of particle size |
| | | | distribution (e.g., by SEM |
| | | | image analysis) could also be |
| | | | utilized (and may even lead |
| | | | to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D10), a |
| | | | fiftieth-percentile volume- |
| | | | weighted particle size |
| | | | parameter (e.g., abbreviated |
| | | | as D50), a ninetieth- |
| | | | percentile volume-weighted |
| | | | particle size parameter (e.g., |
| | | | abbreviated as D90), and a |
| | | | ninety-ninth-percentile |
| | | | volume-weighted particle |
| | | | size parameter (e.g., |
| | | | abbreviated as D99). |
| Active | Width (e.g., | PSA | Parameters relating to |
| Material | nm) | | characteristic widths of the |
| Particle | | | PSD may be derived from |
| Population | | | these particle size |
| | | | parameters, such as D50 − |
| | | | D10 (sometimes referred to |
| | | | herein as a left width), D90 − |
| | | | D50 (sometimes referred to |
| | | | herein as a right width), and |
| | | | D90 − D10 (sometimes |
| | | | referred to herein as a full |
| | | | width). |
| Active | Cumulative | Computed via LPSA | A cumulative volume |
| Material | Volume | data | fraction, defined as a |
| Particle | Fraction | | cumulative volume of the |
| Population | | | composite particles with |
| | | | particle sizes of a threshold |
| | | | particle size or less, divided |
| | | | by a total volume of all of the |
| | | | composite particles, may be |
| | | | estimated by LPSA. |
| Active | Composition | Balance | The mass of active materials |
| Material | (e.g., wt. %) | | added to the electrode |
| Particle | | | divided by the total mass of |
| Population | | | the electrode. |
| Active | BET SSA | BET Isotherm | obtained from the data of |
| Material | (e.g., m²/g) | | nitrogen sorption-desorption |
| Particle | | | at cryogenic temperatures, |
| Population | | | such as about 77K |
| Electrolyte | Salt | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by |
| | | | the mass of the constituents |
| | | | divided by the density. The |
| | | | molar mass of the salt is then |
| | | | used to calculate the total |
| | | | number of moles of salt in |
| | | | the solution. The moles of |
| | | | salt is then divided by the |
| | | | total volume to obtain the |
| | | | solvent concentration in M |
| | | | (mol/L). |
| Electrolyte | Solvent | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by |
| | | | the mass of the constituents |
| | | | divided by the density. The |
| | | | molar volume of each solvent |
| | | | is then used to calculate the |
| | | | total number of moles of |
| | | | solvent in the solution. The |
| | | | moles of solvent is then |
| | | | divided by the total volume |
| | | | to obtain the solvent |
| | | | concentration in M (mol/L). |
| Electrode | Composition | Balance | The mass fraction of a |
| | (e.g., mass | | material (e.g., active |
| | fraction or | | material, active material |
| | wt. %) | | particle, binder, etc.) in the |
| | | | electrode is calculated based |
| | | | on a measured or estimated |
| | | | mass of the material and a |
| | | | measured or estimated mass |
| | | | of the electrode, excluding |
| | | | the electrode current |
| | | | collector. |
| | | | Note: The mass of individual |
| | | | components (e.g., composite |
| | | | active material particles, |
| | | | graphite particles, binder, |
| | | | function additive(s), etc.) of |
| | | | the battery electrode |
| | | | composition may be |
| | | | measured before being |
| | | | mixed into a slurry to |
| | | | estimate their mass in a |
| | | | casted electrode. The mass of |
| | | | materials deposited onto the |
| | | | casted electrode may be |
| | | | measured by comparing the |
| | | | weight of the casted |
| | | | electrode before/after the |
| | | | material deposition. |
| Electrode | Areal Binder | balance | A mass fraction of the |
| | Loading (e.g., | | binder in the battery |
| | mg/m²) | | electrode, divided by a |
| | | | product of (1) a mass |
| | | | fraction of the active |
| | | | material (e.g., Si—C |
| | | | nanocomposite, etc.) |
| | | | particles in the battery |
| | | | electrode, and (2) a |
| | | | Brunauer-Emmett-Teller |
| | | | (BET) specific surface area |
| | | | of the active material |
| | | | particle population. |
| Electrode | Capacity | Calculated | Measure the mass (wt.) of |
| | Attributable | | active material in the |
| | to Active | | electrode, and calculate |
| | Material | | electrode capacity based on |
| | (active | | the known theoretical |
| | material | | capacity of the active |
| | capacity | | material. For example, the |
| | fraction) | | average wt. % of active |
| | | | material in each active |
| | | | material particle may be |
| | | | measured and used to |
| | | | calculate the mass of the |
| | | | active material based on the |
| | | | mass of the active material |
| | | | particles before being mixed |
| | | | in the slurry. This process |
| | | | may be repeated if the |
| | | | electrode includes two or |
| | | | more active materials to |
| | | | calculate the relative |
| | | | capacity attribution for each |
| | | | active material in the |
| | | | electrode. |
| Electrode | Capacity | Potentiostat and | Determine the average |
| | Attributable | balance | specific capacity (mAh/g) of |
| | to Active | | active material particles. For |
| | Material | | example, the average specific |
| | Particles | | capacity may be estimated |
| | (active | | from the average wt. % of |
| | material | | active material(s) in each |
| | particle | | particle and its associated |
| | capacity | | known theoretical |
| | fraction) | | capacity(ies). Then, measure |
| | | | the mass (wt.) of active |
| | | | material particles in the |
| | | | electrode before being mixed |
| | | | in slurry, which may be used |
| | | | to calculate the capacity |
| | | | attributable to that active |
| | | | material. This process may |
| | | | be repeated if the electrode |
| | | | includes two or more active |
| | | | material particle types to |
| | | | calculate the relative |
| | | | capacity attribution for each |
| | | | active material particle type |
| | | | in the electrode. |
| Electrode | Mass of | balance | The average wt. % of active |
| | Active | | material in each active |
| | Material in | | material particle may be |
| | Electrode | | measured, and used to |
| | | | calculate the mass of the |
| | | | active material based on the |
| | | | mass of the active material |
| | | | particles before being mixed |
| | | | in slurry. |
| Electrode | Mass of | balance | Measure the active material |
| | Active | | particle before the active |
| | Material | | material particle type is |
| | Particle in | | mixed in the slurry. |
| | Electrode | | |
| Electrode | Areal | Potentiostat and | Areal capacity loading is the |
| | Capacity | balance | weight of the coated active |
| | Loading (e.g., | | material per unit area |
| | mAh/cm²) | | (g/cm²) multiplied by the |
| | | | gravimetric capacity of the |
| | | | active material (not the |
| | | | electrode, but the active |
| | | | material itself with zero |
| | | | binder and zero electrolyte; |
| | | | mAh/g). |
| Electrode | Coulombic | Potentiostat | The change in charge |
| | Efficiency | | inserted (or extracted) to an |
| | | | electrode divided by the |
| | | | charge extracted (or |
| | | | inserted) from the electrode |
| | | | during a complete |
| | | | electrochemical cycle within |
| | | | given voltage limits. Because |
| | | | the direction of charge flow |
| | | | is opposite for cathodes and |
| | | | anodes, the definition is |
| | | | dependent on the electrode. |
| | | | Coulombic Efficiency is |
| | | | measured for both materials |
| | | | by constructing a so-called |
| | | | half-cell, which is an |
| | | | electrochemical cell |
| | | | consisting of a cathode or |
| | | | anode material of interest as |
| | | | the working electrode and a |
| | | | lithium metal foil which |
| | | | functions as both the counter |
| | | | and reference electrode. |
| | | | Then, charge is either |
| | | | inserted or removed from |
| | | | the material of interest until |
| | | | the cell voltage reaches an |
| | | | appropriate limit. Then, the |
| | | | process is reversed until a |
| | | | second voltage limit is |
| | | | reached, and the charge |
| | | | passed in both steps is used |
| | | | to calculate the Coulombic |
| | | | Efficiency, as described |
| | | | above. |
| Battery Cell | Rate | Potentiostat | This is the time it takes to |
| | Performance | | charge or discharge a |
| | | | battery between a given state |
| | | | of charge. It is measured by |
| | | | charging or discharging a |
| | | | battery and measuring the |
| | | | time until a specified amount |
| | | | of charge is passed, or until |
| | | | the battery operating voltage |
| | | | reaches a specified value. |
| Battery Cell | Cell | Potentiostat | A battery consisting of a |
| | Discharge | | relevant anode and cathode |
| | Voltage (e.g., | | is charged and discharged |
| | V) | | within certain voltage limits |
| | | | and the charge-weighted cell |
| | | | voltage during discharge is |
| | | | computed. |
| Battery Cell | Operating | Potentiostat and | Average temperature of |
| | Temperature | thermocouples | battery cell as measured at |
| | | | the positive/negative |
| | | | terminal/cell shaft/etc. |
| | | | while charging/discharging, |
| | | | or at a certain voltage level, |
| | | | or while a load is applied, |
| | | | etc. |
| Battery | Anode | Potentiostat | An electrode containing an |
| Half-Cell | Discharge | | active anode material (or a |
| | (de- | | mixture of active materials) |
| | lithiation) | | of interest is charged and |
| | Potential | | discharged (by passing |
| | (e.g., V) | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to de- |
| | | | lithiation of the anode) is |
| | | | computed. |
| Battery | Cathode | Potentiostat | An electrode containing an |
| Half-Cell | Discharge | | active cathode material (or a |
| | (lithiation) | | mixture of active materials) |
| | Potential | | of interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to lithiation |
| | | | of the cathode) is computed. |
| Battery Cell | Volumetric | Potentiostat | The VED is calculated by |
| | Energy | | first calculating the energy |
| | Density | | per unit area of the battery, |
| | (VED) | | and then dividing the energy |
| | | | per unit area by the sum of |
| | | | the illustrative anode, |
| | | | cathode, separator, and |
| | | | current collector thicknesses |
| Battery Cell | Internal | Potentiostat | The internal resistance (also |
| | Resistance | | known as impedance in |
| | (impedance) | | many contexts) is measured |
| | | | by applying small pulses of |
| | | | current to the battery cell |
| | | | and recording the |
| | | | instantaneous change in cell |
| | | | voltage. |

While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, alkaline batteries, flow batteries, etc.) as well as electrochemical capacitors and hybrid energy storage devices.

While the description below may describe certain examples in the context of composites comprising alloying-type active anode materials (such as Si, among others), it will be appreciated that various aspects may be applicable to conversion-type active anode and cathode materials, intercalation-type anode and cathode materials, pseudocapacitive anode and cathode materials, and materials that may exhibit mixed electrochemical energy storage mechanisms.

While the description below may also describe certain examples of the material formulations in a Li-free state (for example, as in silicon-comprising nanocomposite anodes or metal fluoride cathodes), it will be appreciated that various aspects may be applicable to Li-containing electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector. Moreover, as used here, an Li-free state is used to refer to a material that is free of electrochemically active Li, and other types of Li such as in electrochemically inactive compounds may (optionally) be part of such an Li-free material.

In certain aspects, the disclosure relates to batteries. While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline ion batteries, flow batteries, etc.).

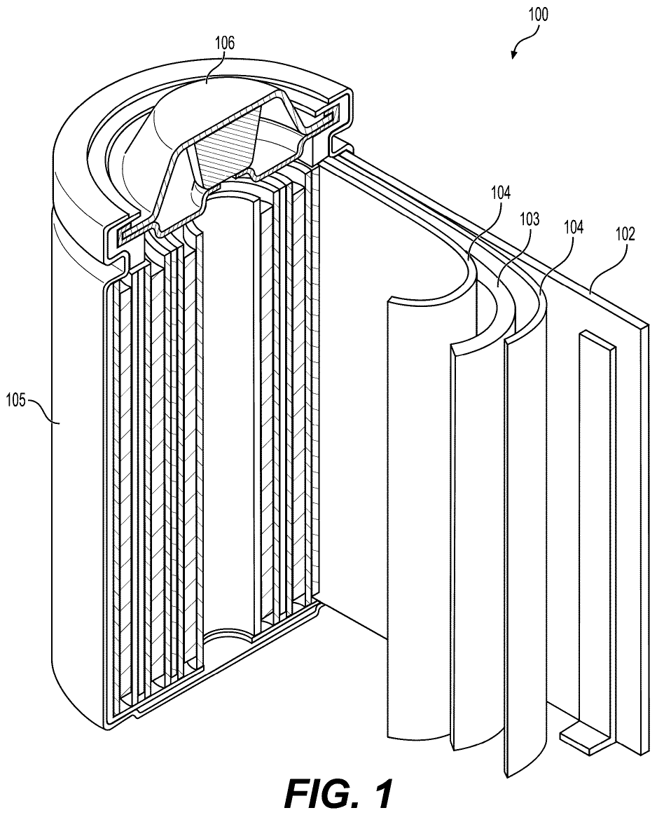

FIG. 1 illustrates an example metal-ion (e.g., Li-ion) battery in which nanowire compositions, separators, electrodes, anode-interlayer components, other components, materials, processes, and other techniques described herein, or combinations thereof, may be applied according to various embodiments. A cylindrical battery is shown here for illustration purposes, but other types of arrangements, including prismatic, coin or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating (infiltrating) the separator 104 (and typically the anode 102 and the cathode 103 as well), a battery case 105, and a sealing member 106 sealing the battery case 105. Herein, metal-ion batteries include those batteries that employ a metal (e.g., Li or Li alloy) as the anode. Li-ion batteries that employ Li or Li alloy as the anode are sometimes referred to as Li-metal batteries.

In some designs, a conversion interlayer is incorporated into a battery. This interlayer is typically positioned between the lithium metal anode and the electrolyte (e.g., solid electrolyte) or the separator in lithium metal batteries. In some designs, depending on its properties, a conversion interlayer may be implemented (1) on the cathode (e.g. LiCoO₂ (LCO) cathode, nickel-rich NCM (LiNiₓCo_{y}M_{1-x-y}O₂) cathode in lithium-ion batteries, (2) on separator, for example, in lithium-sulfur (Li—S) batteries, or (3) on the copper current collector in anode-free lithium-ion batteries. NCM811 is an example of nickel-rich NCM. NCM belongs to a class of cathode compounds called lithium nickel manganese cobalt oxides. Cathode materials that may be employed herein include: lithium iron phosphate (LFP), lithium nickel manganese cobalt oxide, lithium cobalt oxide, lithium nickel cobalt aluminum oxide, and lithium manganese oxide.

In some designs, electrolyte (e.g., in the form of a solid electrolyte) may be used as the separator (or separator membrane) 104, while in other designs the electrolyte (e.g., in the form of a liquid electrolyte) may infiltrate one or more other separator components (e.g., a porous polymeric separator component, a porous ceramic component, etc.). The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on and/or in the anode current collector and the cathode is disposed on and/or in the cathode current collector (e.g., some/all of an electrode (or electrode interlayer) may be deposited “in” a current collector in the case of porous current collectors).

Conventional electrolytes for Li- or Na-based batteries of this type are generally composed of an about 0.8-1.2 M (about 1 M±about 0.2 M) solution of a single Li or Na salt (such as LiPF₆ for Li-ion batteries and NaPF₆ or NaClO₄ salts for Na-ion batteries) in a mixture of carbonate solvents with about 1-2 wt. % of other organic additives. Common organic additives may include nitriles, esters, sulfones, sulfoxides, phosphorous-based solvents, silicon-based solvents, ethers, ketones, boron-based compounds, and others. Such additive solvents may be modified (e.g., sulfonated or fluorinated). Higher (e.g., about 1.2-4.0 M) or lower (e.g., about 0.1-0.8 M) salt concentration may be used in some electrolyte designs in the context of the present disclosure. Furthermore, two, three or more different salts may be used in some electrolyte designs in the context of the present disclosure.

Examples of less common salts (e.g., explored primarily in research publications or, in some cases, never even described in Li-ion battery electrolyte applications, but may still be applicable and useful) include: lithium tetrafluoroborate (LiBF₄), lithium perchlorate (LiClO₄), lithium hexafluoroantimonate (LiSbF₆), lithium hexafluorosilicate (Li₂SiF₆), lithium hexafluoroaluminate (Li₃AlF₆), lithium bis(oxalato)borate (LiB(C₂O₄)₂), lithium difluoro(oxalate)borate (LiBF₂(C₂O₄)), various lithium imides (such as SO₂FN⁻(Li⁺)SO₂F, CF₃SO₂N⁻(Li⁺)SO₂CF₃, CF₃CF₂SO₂N⁻(Li⁺)SO₂CF₃, CF₃CF₂SO₂N⁻(Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅ or CF₃SO₂N⁻(Li⁺)SO₂PhCF₃, and others), lithium difluorophosphate, and others.

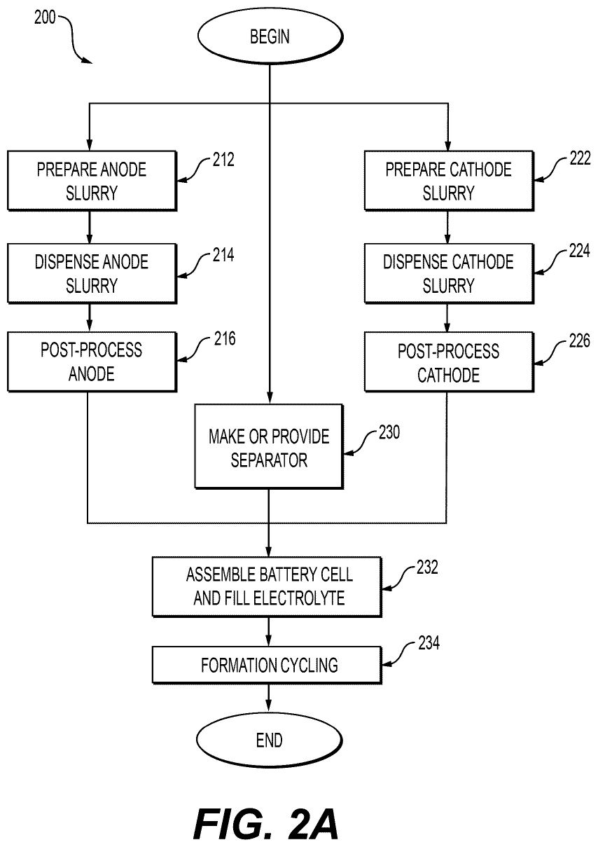

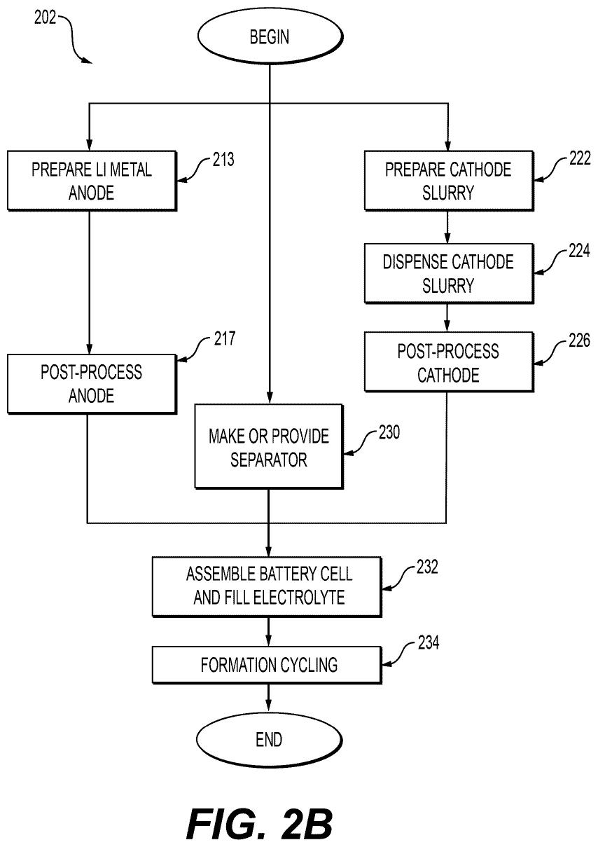

FIG. 2A illustrates an example process 200 of making a Li-ion battery in which each electrode is formed by dispensing a respective electrode slurry (with each slurry comprising a suitable battery electrode composition). This example shows the formation of both electrodes (anode and cathode). The flow diagram includes a left branch, a right branch, and a middle branch. The left branch relates to the formation of an anode, and includes stages 212, 214, and 216. The right branch relates to the formation of a cathode, and includes stages 222, 224, and 226. The middle branch relates to making or providing a separator and includes stage 230. For each of the left and right branches, an electrode (an anode or a cathode) may be formed by casting from a slurry onto and/or into a current collector. At stage 230, a separator is made or otherwise provided. In the example shown, the left, the middle, and the right branches may be carried out concurrently or sequentially as desired. In addition, process 200 also includes stages 232 and 234, which are carried out after the left, the middle, and the right branches have been carried out. At stage 230, a separator is made or otherwise provided (e.g., a commercially available separator), as described herein. Stage 232 includes assembling of the battery cell from the battery components (e.g., anode, anode interlayer component, cathode, separator, battery case, sealing member) and filling the cell with an electrolyte. Stage 234 includes carrying out any formation cycling on the assembled battery, to form a solid-electrolyte interphase (SEI) layer in the anode and/or the cathode.

In still further aspects, the battery electrode (anode or cathode) composition may comprise active materials suitable for a specific battery. The battery electrode composition may comprise, for example, (e.g., particles comprising) graphite or graphitic active materials (e.g., synthetic graphite, natural graphite, hard carbon, and/or soft carbon, etc.), silicon oxide, silicon nitride or, more broadly, silicon-comprising active materials (including composites or (nano)composites, such as Si—C (nano)composites, among others), metal oxide (e.g., lithium titanate, niobium oxide, niobium titanium oxide, lithium niobium titanium oxide, vanadium oxide, lithium vanadium oxide, etc.) and other active anode materials, conductive additives, other functional additives, but may be substantially free of solvents (e.g., after the solvents of the slurry have evaporated to form an electrode coating). In certain aspects, the anode active materials may be provided as particles or as core-shell particles or composite anode particles. In still further aspects, the anode active materials may comprise Si-comprising composite particles whereby Si-comprising active material is deposited within pore(s) of a particle core.

The battery electrode (e.g., anode electrode) composition, as described herein, may comprise composite particles, wherein each of the composite particles may comprise carbon and silicon. It is understood that a ratio of carbon and silicon in the composite particles can be any ratio that provides the desired battery performance. In some embodiments, a mass fraction of the silicon in the Si-comprising composite particles is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 50 wt. % to about 60 wt. %; in yet other designs, from about 60 wt. % to about 70 wt. %; in yet other designs, from about 70 wt. % to about 80 wt. %; in yet other designs, from about 20 wt. % to about 80 wt. %; in yet other designs, from about 35 wt. % to about 60 wt. %).

In certain aspects, each or some of the composite particles may be present in a core-shell configuration. Yet in still further aspects, at least a portion of the composite particles is present in a core-shell configuration.

In still further aspects, the suitable electrode materials may advantageously comprise conductive fillers (conductive additives). It is understood that the terms conductive fillers and conductive additive compositions can be used interchangeably. In such exemplary and unlimiting aspects, the conductive additive compositions may comprise one, two, or more of the following: carbon, carbon black, modified carbon, modified carbon black, dendritic carbon, graphene (incl. single-layered graphene and/or multi-layered graphene with about 2 to about 40 layers, on average (e.g., in some designs, from about 2 to about 10 layers; in other designs, from about 10 to about 20; in other designs, from about 20 to about 30; in yet other designs, from about 30 to about 40 layers, on average), graphene oxide, graphite, exfoliated graphite, carbon (nano)tubes (e.g., single-walled carbon (nano)tubes (SWCNTs), multi-walled carbon (nano)tubes (MWCNTs)), carbon (nano)fibers, carbon fibers, carbon (nano)flakes, graphite ribbons, salts of carboxymethyl cellulose (CMC) or salts of alginic acid (note that CMC and alginates are not conductive, but may help to disperse conductive additives), or any combination thereof.

Referring to FIG. 2A, the method of forming the electrode first comprises preparing an electrode slurry (stages 212 and 222). At stage 212, the anode slurry may be formed by mixing the anode active material with a binder, a solvent, any conductive additives, and any other functional additives. At stage 222, the cathode slurry may be formed by mixing the cathode active material with a binder, a solvent, any conductive additives, and any other functional additives.

In still further aspects, an electrode slurry (anode slurry or cathode slurry) is dispensed onto and/or into a respective current collector at stages 214 and 224, respectively. The dispensing may be carried out using any suitable coating process, including slot die coating and blade coating. The dispensing may be carried out in a roll-to-roll process, with the current collector being in the form of a roll and being in an unrolled state during the dispensing.

In certain aspects, the current collector can comprise a metal foil, metal wire, metal mesh, or any combination thereof. In certain aspects, the current collector can comprise a metallized foil. Metallized foils may be employed in some applications for which the mass of the current collector is preferably reduced as much as possible, e.g., in applications for which the gravimetric energy density is preferably as high as possible. Metallized foils are formed by forming a thin layer of metal (e.g., Cu or Cu alloy, Al or Al alloy, Ni or Ni alloy, Ti or Ti alloy, Mo or Mo alloy, Fe or Fe alloy, steel) on a substrate that is lighter than the metal (e.g., a plastic substrate such as poly(ethylene terephthalate) (PET)). In certain aspects, the current collector can comprise Cu or Cu-alloy foil for anodes and Al or Al-alloy foil for cathodes, in many instances.

In some aspects, the current collector can comprise a graphene coating, a carbon coating or film, carbon nanotubes (CNTs), and/or carbon nanofibers (CNFs). In some aspects, graphene can be deposited as a thin coating on substrates using techniques like chemical vapor deposition (CVD), spray-coating, or spin-coating. Graphene sheets can be assembled into free-standing films or papers that act as lightweight current collectors. In some aspects, graphene is coated on traditional copper foil to enhance the conductivity and reduce the reactivity of copper with lithium. In some aspects, carbon can be deposited as a thin film onto a copper or aluminum substrate by PVD techniques. In some aspects, carbon films can also be deposited by electrochemical techniques, forming a thin, even layer. In some aspects, carbon slurry (carbon powder mixed with a binder) can be coated onto a substrate and then dried to form a uniform, conductive carbon layer. In some aspects, CNTs can be fabricated into a 3D conductive scaffold by methods such as vacuum filtration, electrospinning, or layer-by-layer assembly. In some aspects, a layer of CNTs can be deposited on traditional metal current collectors to improve conductivity and reduce lithium's direct contact with the metal. In some aspects, CNT films or “buckypapers” can be prepared as free-standing current collectors, which are then attached to the anode in the battery cell. In some aspects, CNFs can be fabricated using electrospinning to create a 3D porous mat. This mat serves as a flexible, high-surface-area current collector that supports uniform lithium deposition. In some aspects, CNFs can be deposited as a coating on metal foils to improve their stability with lithium and reduce weight. In some aspects, CNFs can be combined with other carbon materials, such as graphene or CNTs, to form hybrid structures with enhanced conductivity and mechanical stability.

In still further aspects, at stages 216 and 226, the dispensed electrode compositions (either an anode composition or a cathode composition, formed by dispensing the respective slurry) are dried to completely evaporate the solvent, to form an electrode coating. At stages 216 and 226, any other post-dispensing process stages may be carried out on the electrode coating. For example, the dispensed compositions may undergo a calendering process (compaction), which may be carried out after the drying (solvent evaporation) process. Stages 216 and 226 may additionally include other processes, such as cutting the electrode-current collector to suitable dimensions (e.g., cutting a roll of the electrode-current collector into individual pieces for assembly into a battery).

In some implementations, stage 216 and/or stage 226 may additionally include the formation of a conversion interlayer on the anode and/or the cathode. If the conversion interlayer is in the form of a free-standing membrane, the membrane may be positioned directly on the electrode. Implementations of an aluminum fluoride free-standing membrane (e.g., for use on the anode) are disclosed herein. In the case of a free-standing membrane, stage 216 and/or stage 226 may also include other suitable preparation of the membrane such as cutting the membrane to size. In other implementations, a conversion interlayer may be in the form of a coating that is deposited or otherwise directly formed on the electrode. In some implementations, a coating of aluminum fluoride nanowires or aluminum fluoride nanoparticles (including elongate nanoparticles) may be formed on the anode. In anode implementations in which the anode active material comprises Si (e.g., Si—C (nano)composite particles with Si and C in each (nano)composite particle), an AlF₃ coating can mediate the composition of the SEI formed on Si-comprising anodes by the transformation of AlF₃ into Li—Al—F compounds. In some implementations, the formed SEI with inorganic (i.e., LiF)-rich species increase the cycling stability of Si-comprising anodes. Techniques that are available for such deposition or formation processes include: atomic layer deposition (ALD), chemical vapor deposition (CVD), sol-gel processing, electrochemical deposition, in-situ formation during cycling (of a subsequently formed electrochemical cell such as a battery cell), spray-based coating, dip coating, reverse gravure coating, wire-bar coating, blade coating, slot-die coating, and electrostatic jet coating. Wet-coating techniques such as spray-based coating, dip coating, reverse gravure coating, wire-bar coating, blade coating, and slot-die coating may be employed to deposit a coating from a slurry (dispersion) that comprises a nanowire composition (e.g., aluminum fluoride nanowires (AFNWs). In some implementations, stage 230 may be omitted. In some cases, if the conversion interlayer is in the form of a membrane (e.g., free-standing membrane) of AFNWs that can additionally function as a separator, a separator (as provided or made at stage 230) may be omitted.

In ALD, a vapor-phase technique is employed to deposit thin, conformal layers of materials, such as Al₂O₃, TiO₂, or ZrO₂, onto electrode surfaces with atomic-level precision, ensuring uniform coverage. In the CVD process, a vapor-phase chemical reaction deposits a thin, durable coating onto the electrode surface, enhancing the electrode's stability and functionality. The sol-gel method involves dissolving metal precursors in a liquid solution to form a “sol,” which is then applied to the electrode surface and transformed into a gel form to create a robust coating. Electrochemical deposition involves the reduction of ions of the coating material directly onto the electrode surface through an applied electric current, forming a uniform layer with high adhesion properties. The foregoing vapor-phase deposition techniques may also be employed to implement core-shell particle designs. Core-shell designs involve directly coating the electrode particles to form a shell around a high-capacity core, providing additional stability and durability.

In some implementations, conversion layers may also be formed in-situ during initial battery cycles as a result of controlled reactions between the electrode and electrolyte or through the use of specific additives. Wet coating techniques (e.g., spray-based coating, dip coating, reverse gravure coating, wire-bar coating, slot-die coating) include applying a slurry containing the coating material-such as the AFNWs, conductive polymers, ceramic particles, metal oxides, etc. by spraying or dipping or otherwise coating the electrode, followed by drying of the slurry to form the layer (e.g., on the electrode).

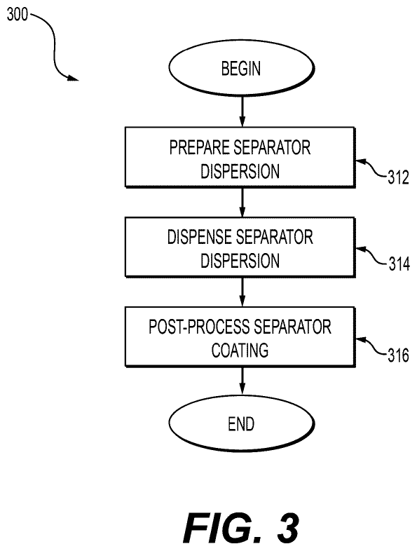

In some implementations, stage 230 may include making a separator. An example process 300 for making a separator is shown in FIG. 3. Process 300 includes stages 312, 314, and 316. Stage 312 includes preparing a separator dispersion. At stage 312, the separator dispersion may be formed by mixing ceramic (nano)particles (e.g., elongate ceramic (nano)particles) with a solvent, any binder, and any other functional additives (e.g., surfactants, dispersants, flame retardants). Herein, examples of solvents include water and organic solvents including alcohols and N-Methyl-2-pyrrolidone (NMP). Herein, a solvent may be a mixture of suitable solvent compounds. At stage 314, the separator dispersion (e.g., obtained from stage 312) is dispensed on a substrate (e.g., a porous polymer membrane or an electrode or a sacrificial substrate, etc.). The dispensing may be carried out using any suitable coating process, including slot-die coating, reverse gravure coating, wire-bar coating, blade coating, spray-based coating, and electrostatic jet coating. The dispensing may be carried out in a roll-to-roll process, with the substrate being in the form of a roll and being in an unrolled state during the dispensing. At stage 316, the dispensed separator composition is dried to completely evaporate the solvent, to form the separator coating. At stage 316, any other post-dispensing process stages may be carried out on the separator coating. Stage 316 may additionally include other processes, such as cutting the separator to suitable dimensions (e.g., cutting a roll of the separator into individual separator pieces for assembly into a battery). Accordingly, a separator is formed from carrying out process 300. In some implementations, the dispensing at stage 312 is carried out on a polymer membrane (e.g., polyolefin membrane) as the substrate.

In some implementations, a conversion layer (e.g., AlF₃ interlayer, including AlF₃ in the form of a membrane or a coating of AlF₃ nanowires or nanoparticles including elongate nanoparticles) is disposed or deposited on a separator. Positioned on the surface of the separator, this layer typically interacts with active species in the electrolyte or electrode materials to improve electrochemical reactions, inhibit side reactions, and manage the transport of ions. The conversion layer can serve multiple purposes, such as trapping unwanted intermediates, catalyzing electrochemical processes, and preventing the crossover of reactive species. For example, in lithium-sulfur batteries, the conversion layer can mitigate the shuttle effect by capturing polysulfides and converting them back into active materials. In lithium-ion or lithium-metal batteries, the layer can enhance stability by suppressing dendrite growth or reducing parasitic reactions. In some examples, AlF₃ nanomaterials may be coated on a commercial polypropylene (PP) separator for potassium (K) metal batteries. The AlF₃:PP separator can promote more complete electrolyte wetting and may enhance electrolyte uptake, improve ionic conductivity, and increase the ion transference number. In some examples, the AlF₃-coated separator may promote the formation of an artificial SEI on the K metal surface.

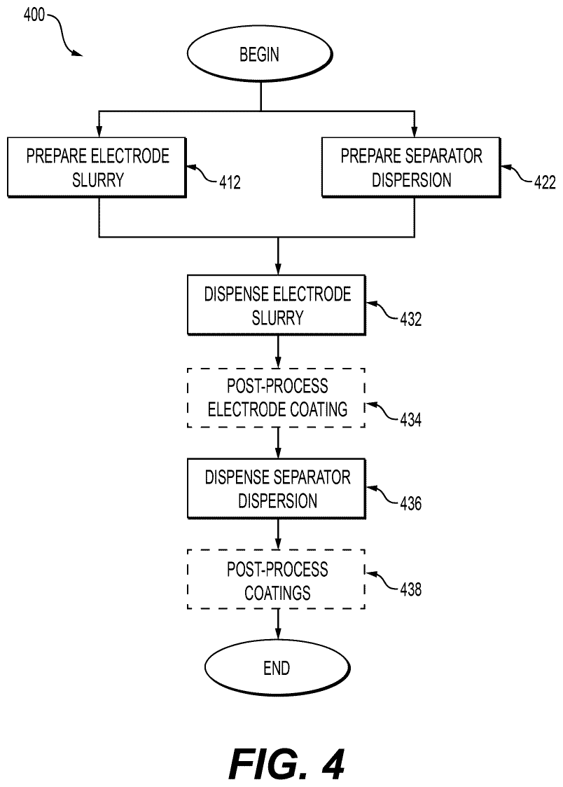

In some implementations, stage 230 may be modified. One modification is that the separator may be integrated with an electrode (anode or cathode or both); such a component may be referred to as an integrated electrode-separator component. An example process 400 for making an integrated electrode-separator component is shown in FIG. 4. Process 400 includes stages 412, 422, 432, 434, 436, and 438. Some aspects of stage 434 may be optional, as explained below. Stage 412 includes preparing an electrode slurry. At stage 412, an electrode slurry (anode slurry or cathode slurry) may be formed by mixing the electrode active material (anode active material or cathode active material) with a binder, a solvent, any conductive additives, and any other functional additives. Stage 422 includes preparing a separator dispersion. At stage 422, the separator dispersion may be formed by mixing ceramic (nano)particles with a solvent, any binder, and any other functional additives (e.g., surfactants, dispersants, flame retardants). Stage 432 includes dispensing the electrode slurry (anode slurry or cathode slurry) onto and/or into a current collector. The dispensing of the electrode slurry may be carried out using any suitable coating process, including slot die coating and blade coating. The dispensing of the electrode slurry may be carried out in a roll-to-roll process, with the current collector being in the form of a roll and being in an unrolled state during the dispensing of the electrode slurry. At stage 434, the dispensed electrode composition (either an anode composition or a cathode composition, formed by dispensing the respective slurry) is dried to completely evaporate the solvent, to form an electrode coating. At stage 434, any other post-dispensing process stages may be carried out on the electrode coating. For example, the dispensed compositions may undergo a calendering process (compaction), which may be carried out after the drying (solvent evaporation) process. At stage 436, the separator dispersion (e.g., obtained from stage 422) is dispensed on the substrate, which is the current collector with the electrode coating formed thereon. The dispensing of the separator dispersion is carried out such that the separator coating comes into intimate contact with the electrode coating. The dispensing of the separator dispersion may be carried out using any suitable coating process, including slot-die coating, reverse gravure coating (kiss coating), wire-bar coating, blade coating, spray-based coating, and electrostatic jet coating. The dispensing of the separator dispersion may be carried out in a roll-to-roll process, with the substrate being in the form of a roll and being in an unrolled state during the dispensing of the separator dispersion. At stage 438, the dispensed separator composition is dried to completely evaporate the solvent, to form the separator coating. At stage 438, any other post-dispensing process stages may be carried out on the separator coating. For example, the dispensed compositions may undergo a calendering process (compaction), which may be carried out after the drying (solvent evaporation) process. Stage 438 may additionally include other processes, such as cutting the integrated electrode-separator to suitable dimensions (e.g., cutting a roll of the integrated electrode-separator into individual integrated electrode-separator pieces for assembly into a battery). In some implementations, portions of the post-dispensing processes at stage 434 may be omitted. For example, a calendering process during stage 434 may be omitted since the subsequent stage 438 may include a calendering process which would result in the compaction of both the separator coating and the electrode coating. In some implementations, portions of the post-dispensing processes at stage 438 may be omitted. For example, a calendering process may be carried out at stage 434, which results in a compaction of the electrode coating, but a calendering process may be omitted at stage 438. In this example, the electrode coating undergoes calendering (compaction) but the electrode coating-separator coating combination does not undergo calendering (compaction).

In some implementations, the left branch of the example process 200 is adapted to prepare an anode or an anode-interlayer component for a Li metal battery. FIG. 2B illustrates an example process 202 for preparing a Li metal battery. In FIG. 2B, the left branch includes stages 213 and 217. At stage 213, a Li metal foil or a composite Li anode is prepared. In some examples, a composite Li anode comprises a layer of lithium metal deposited on and/or in a current collector (e.g., Cu or Cu alloy, Al or Al alloy, Ni or Ni alloy, Ti or Ti alloy, Mo or Mo alloy, Fe or Fe alloy, steel). Lithium metal is handled in an inert atmosphere (e.g., argon, nitrogen) to prevent reactions with moisture and oxygen. A composite lithium metal anode may be formed on a current collector substrate by a suitable deposition process such as electrodeposition or vapor-phase deposition. In some implementations, the left branch includes stage 217, during which a conversion interlayer (e.g., AFNW interlayer) is formed on the anode. The conversion interlayer may be in the form of a membrane (e.g., a free-standing membrane) that is placed on an anode (e.g., Li metal foil, composite Li anode or bare (e.g., bare copper) current collector to form an anode-interlayer component, as described herein. In some other implementations, a conversion interlayer coating may be deposited or formed on the Li metal foil, the composite Li anode or the current collector at stage 217. At stage 217, the anode (e.g., lithium metal foil, composite Li metal anode, or anode-interlayer component) is cut and shaped to the desired size. This process occurs in an inert atmosphere to prevent oxidation of the lithium metal. The preparation of the cathode material may remain largely the same as shown in FIG. 2A, as the cathode materials used in Li-ion batteries are generally compatible with Li-metal batteries. Handling in a clean and inert environment is preferred to obtain satisfactory performance from the cathode material. At stage 230, a ceramic-coated separator or a separator with high mechanical strength (e.g., using ceramic or other stable, dendrite-resistant materials) may be used. In some implementations, stage 230 may be omitted. In some cases, if the conversion interlayer is in the form of a membrane (e.g., free-standing membrane) of AFNWs that can additionally function as a separator, a separator (as provided or made at stage 230) may be omitted. During the assembly process at stage 232, the lithium metal anode is handled in an inert atmosphere to prevent oxidation or reactions with moisture. Formation cycling at stage 234 for a Li-metal battery may involve slow initial charge cycles (e.g., at low current densities to avoid stressing the anode) to form a stable SEI layer on the lithium metal anode.

A solid-state electrolyte (SSE) or a liquid electrolyte that prevents dendrite formation and is stable with lithium metal are usually used in Li-metal batteries. The electrolyte composition may include lithium bis(fluorosulfonyl)imide (LiFSI), lithium bis(trifluoromethanesulfonyl) imide (LiTFSI), or LiPF₆ to enhance the stability of the lithium metal anode. Also, the electrolyte may contain additives (e.g., fluoroethylene carbonate (FEC), lithium difluoro(oxalato)borate (LiDFOB), LiNO₃ (Lithium Nitrate), dimethyl sulfide (DMS), tris(trimethylsilyl)phosphite (TMSPi), organophosphates, 1,3-dioxolane (DOL), tetraethylene glycol dimethyl ether (TEGDME), bis(trifluoromethanesulfonyl)imide (TFSI), polymers containing polar functional groups) that suppress dendrite growth.

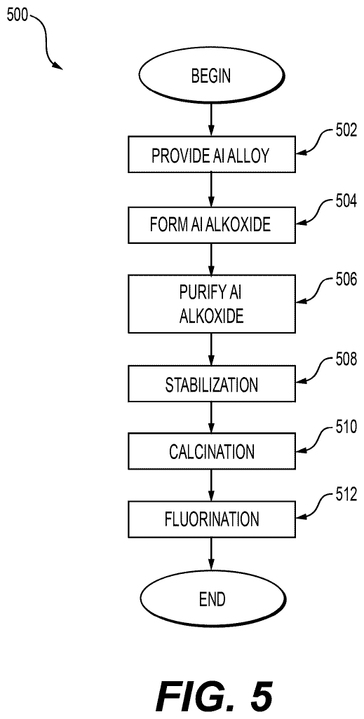

FIG. 5 shows an example process for synthesizing one-dimensional (1D) inorganic nanomaterials with a high aspect ratio, such as nanowires (NWs) or nanofibers. The synthesis pathway 500 is based on dealloying conversion reactions that are governed by stress energy reduction and/or minimization. In an aspect, this method allows for the production of alkoxide and oxide NWs at near room temperature and atmospheric pressure, without the use of toxic or corrosive chemicals.

At stage 502, a high-purity (e.g., purity of about 98% or greater, purity of about 99% or greater) aluminum-lithium (AlLi) alloy is provided. In some implementations, the mass fraction of Li in the AlLi alloy is in a range of about 0.1% to about 20 wt. %. At stage 504, particles of the AlLi alloy are dispersed in an anhydrous alcohol (e.g., anhydrous methanol, anhydrous ethanol, anhydrous propanol, anhydrous butanol); reaction products formed from the reactions between the AlLi alloy and the anhydrous alcohol include aluminum alkoxide particles (e.g., aluminum alkoxide NWs, bundles of aluminum alkoxide NWs, and other aluminum alkoxide particles). The anhydrous alcohol can be anhydrous methanol, anhydrous ethanol, anhydrous propanol, anhydrous butanol, or any combination thereof. In implementations in which the anhydrous alcohol is anhydrous ethanol, the aluminum alkoxide is aluminum ethoxide. A homogeneous dispersion of the aluminum alkoxide particles is obtained at stage 504. Stage 506 includes purification of the reaction product by filtration (e.g., using additional anhydrous alcohol) to obtain aluminum alkoxide particles of greater purity. At stage 508, the purified Al alkoxide particles are dried and stabilized in air. At stage 510, the Al alkoxide particles undergo calcination (also referred to as heat treatment or annealing) at a temperature in a range of approximately 300-600° C. (e.g., in a range of about 300° C. to about 350° C., in a range of about 350° C. to about 400° C., in a range of about 400° C. to about 450° C., in a range of about 450° C. to about 500° C., in a range of about 500° C. to about 550° C., or in a range of about 550° C. to about 600° C.) to be transformed to alumina (Al₂O₃) particles. At stage 512, the A12O₃ particles are then subjected to a fluorination treatment using a fluorinating gas to convert the A12O₃ particles into AlF₃ particles. Any suitable fluorinating gas may be employed. Some fluorinating gases are: nitrogen trifluoride (NF₃) gas, hydrogen fluoride (HF) gas, fluorine (F₂) gas, chlorine trifluoride (ClF₃) gas, sulfur hexafluoride (SF₆) gas, and chlorodifluoromethane (CHClF₂) gas, or any combination thereof.

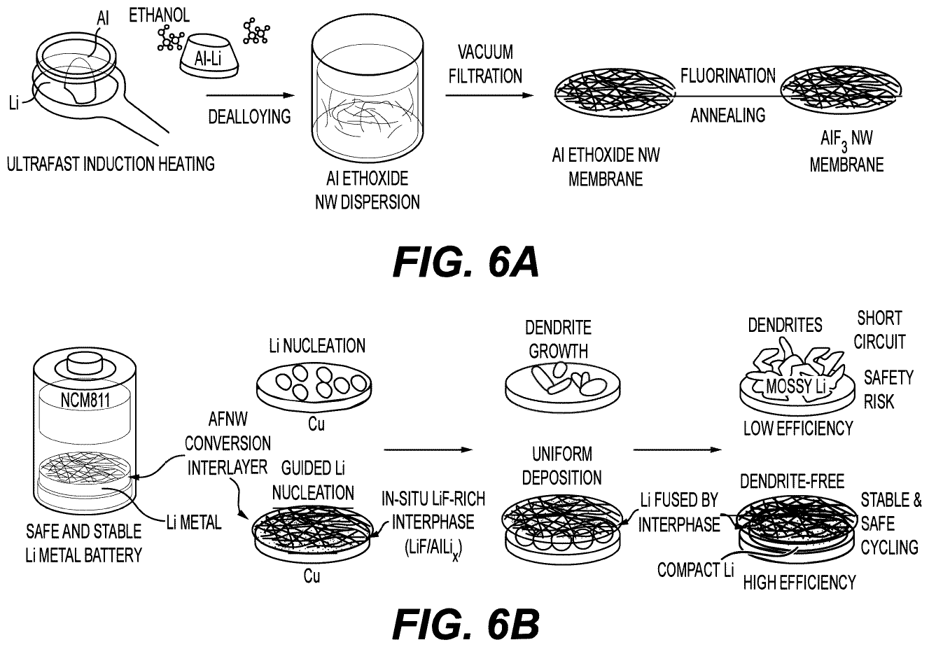

Process 500 may be implemented to make a free-standing thin membrane of aluminum fluoride nanowires. An example of such implementations is depicted in FIG. 6A. After preparing a bulk Al—Li alloy using ultrafast induction heating followed by dealloying the alloy in an anhydrous alcohol for 2-6 days (e.g., in a range of 2 to 3 days, in a range of 3 to 4 days, in a range of 4 to 5 days, or in a range of 5 to 6 days) to form a homogeneous dispersion of ultralong Al alkoxide NWs, the dispersion of the Al alkoxide NWs is filtered (e.g., through a silicone-treated phase separator in a glovebox) under vacuum to form a free-standing thin membrane comprising the Al alkoxide NWs. The alcohol can be methanol, ethanol, propanol, butanol, or any combination thereof. Since the Al alkoxide NWs are homogeneously dispersed in the alcohol, the size and thickness of the resulting membranes can be readily controlled by adjusting the quantity of the dispersion. After stabilizing the free-standing Al alkoxide NW membrane in air, the Al alkoxide NW membrane is annealed at a temperature in a range of approximately 300-600° C. (e.g., in a range of about 300° C. to about 350° C., in a range of about 350° C. to about 400° C., in a range of about 400° C. to about 450° C., in a range of about 450° C. to about 500° C., in a range of about 500° C. to about 550° C., or in a range of about 550° C. to about 600° C.) for 1-4 hours (e.g., in a range of 1 to 2 h, in a range of 2 to 3 h, or in a range of 3 to 4 h) converting the Al alkoxide NWs into amorphous Al₂O₃ NWs. The Al₂O₃ NWs are then subjected to a fluorination treatment using a fluorinating gas to convert the Al₂O₃ NWs into AFNWs to produce a free-standing AFNW membrane. The fluorinating gas can be nitrogen trifluoride (NF₃) gas, trifluoride (NF₃) gas, hydrogen fluoride (HF) gas, fluorine (F₂) gas, chlorine trifluoride (ClF₃) gas, sulfur hexafluoride (SF₆) gas, and chlorodifluoromethane (CHClF₂) gas, or any combination thereof. In some implementations, the free-standing Al₂O₃ NW membranes were placed in a tube furnace and heated to about 300-500° C. (e.g., about 350° C., about 400° C., about 450° C., etc.) for 2-4 h (e.g., in a range of 2.0 to 2.5 h, in a range of 2.5 to 3.0 h, in a range of 3.0 to 3.5 h, or in a range of 3.5 to 4.0 h) with a gas flow of about 1%-about 3% (e.g., in a range of about 1.0 to about 1.5%, in a range of about 1.5 to about 2.0%, in a range of about 2.0 to about 2.5%, or in a range of about 2.5 to about 3.0%) of nitrogen fluoride (NF₃) mixed in helium (He) to convert the amorphous Al₂O₃ into α-phase AFNWs. To prevent exposure to air/moisture, the samples were immediately transferred into the glovebox and stored for future use.

In some implementations, the free-standing AFNW membrane can be placed on a composite Li anode (e.g., lithium metal deposited on a bare (e.g., bare copper) current collector) or directly on a bare copper current collector to form an anode-interlayer component. In some implementations, the AFNW membrane of the anode-interlayer component can serve as a separator.

In some other implementations, a layer of AlF₃ nanoparticles is coated on a composite Li anode (e.g., lithium metal deposited on a bare (e.g., bare copper) current collector) or directly on a bare copper current collector to form an anode-interlayer component. In some implementations, elongate AlF₃ nanoparticles can be prepared by milling the produced AFNWs obtained in the process as illustrated in FIG. 6A. For example, the AFNWs may be milled by exposing the AFNWs to hard plastic or ceramic media in rotational or orbital motion in an orbital mixer or a shaker table. In some implementations, the elongate AlF₃ nanoparticles are obtained after milling. The elongate AlF₃ nanoparticles exhibit aspect ratios of about 1:3 or greater. The elongate AlF₃ nanoparticles have lengths (i.e., lengths along the elongate direction of each respective elongate AlF₃ nanoparticle) of about 2 μm or greater (e.g., in a range of about 2 to about 50 μm, in a range of about 5 μm to about 45 μm, in a range of about 10 μm to about 50 μm, in a range of about 15 μm to about 35 μm, in a range of about 20 μm to about 40 μm, in a range of about 30 μm to about 50 μm or in a range of about 25 μm to about 45 μm). The elongate AlF₃ nanoparticles have transverse dimensions (e.g., widths) in directions perpendicular to the elongate direction in a range of about 1 to about 500 nm (e.g., in a range of about 1 to about 100 nm, in a range of about 10 nm to about 300 nm, in a range of about 50 nm to about 400 nm, in a range of about 100 nm to about 500 nm, in a range of about 200 nm to about 500 nm, in a range of about 250 nm to approximately 400 nm, in a range of about 300 nm to approximately 450 nm).

The elongate AlF₃ nanoparticles can be coated on a composite Li anode (e.g., lithium metal on a bare copper current collector) or directly on a bare (e.g., bare copper) current collector to form an anode-interlayer component. In some implementations, the elongate AlF₃ nanoparticles are dispersed in a solvent (e.g., anhydrous ethanol) to form a slurry. The slurry may also include other components such as binders, surfactants, and additives. Wet-coating techniques such as spin coating, spray-based coating, dip coating, reverse gravure coating, wire-bar coating, blade coating, and slot-die coating may be employed to deposit a coating from a slurry (dispersion) that comprises a nanowire composition (e.g., aluminum fluoride nanowires (AFNWs) on the Li metal surface or the bare (e.g., bare Cu) current collector surface. After coating, drying the Li anode in an inert atmosphere or under vacuum ensures that the solvent evaporates, leaving behind a layer of AlF₃ nanoparticles. This approach requires the lithium surface to be cleaned and possibly pre-activated to improve adhesion. In some implementations, a mild annealing stage (at a temperature that is low enough that the Li metal does not melt, the melting point of Li is about 180.5° C.) in an inert atmosphere may improve the adhesion and uniformity of the AlF₃ nanoparticle layer. In some implementations, the AlF₃ nanoparticle coating of the anode-interlayer component can serve as a separator.

In some other implementations, atomic layer deposition (ALD) is employed to form an anode-interlayer component. In an example ALD process, alternating pulses of aluminum and fluoride precursors (e.g., trimethylaluminum and anhydrous hydrogen fluoride gas) is used to deposit a thin, uniform AlF₃ layer on the Li metal surface or bare (e.g., bare Cu) current collector surface. The ALD process allows for precise thickness control and conformal coverage, which is especially useful for nanoscale coatings on reactive lithium surfaces. The ALD process of AlF₃ typically occurs at low temperatures to prevent Li metal from melting. In some implementations, the AlF₃ coating of the anode-interlayer component can serve as a separator.

In some implementations, a free-standing AFNW membrane is positioned not on a composite Li anode or a bare (e.g., bare copper) current collector, but rather on the separator of a Li metal battery. In some implementations, a coating of elongate AlF₃ nanoparticles is deposited not on a composite Li anode or a bare (e.g., bare Cu) current collector, but rather on the separator of a Li metal battery.

In some implementations, a free-standing AFNW membrane or a coating of AlF₃ nanoparticles (e.g., deposited on a composite Li anode or a bare (e.g., bare Cu) current collector) can also serve as the separator of a Li metal battery. In these implementations, an additional separator is not required.

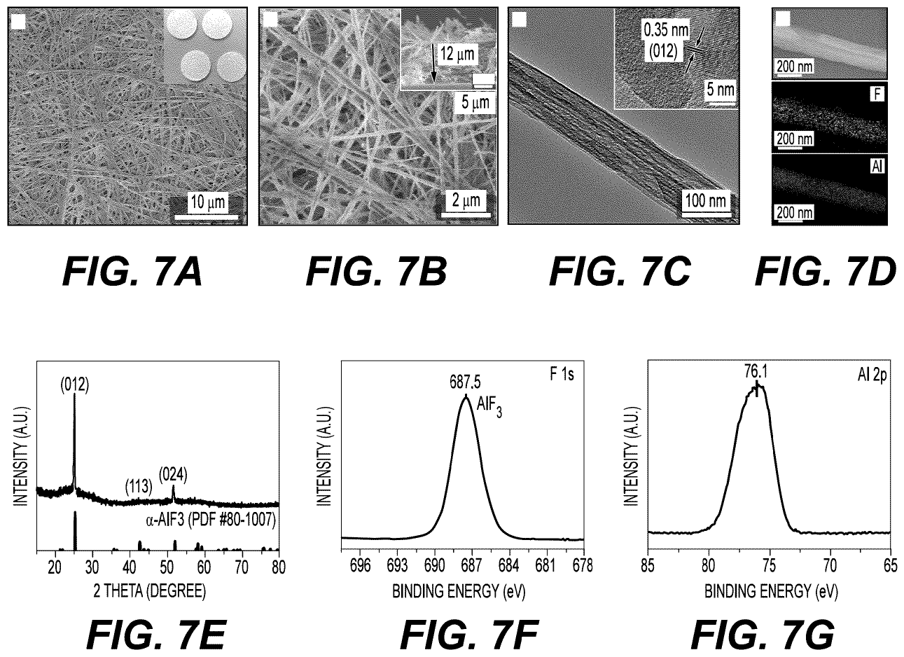

FIG. 7A and FIG. 7B show SEM images of the AFNW membranes, which reveal a uniform nonwoven network composed of ultralong NWs. The dimensions of the AFNWs are similar to those of their precursors, including the Al alkoxide NWs prior to annealing and the amorphous Al₂O₃ NWs prior to fluorination, although the AFNWs exhibit a rougher surface. In one or more implementations of the present disclosure, the average diameter of individual NWs (of various compositions) may range from about 100.0 nm to about 500.0 nm (e.g., in a range of about 100.0 nm to about 200.0 nm; in a range of about 150.0 nm to about 300.0 nm; in a range of about 200.0 nm to about 400.0 nm; in a range of about 250.0 nm to about 450.0 nm; in a range of about 150.0 nm to about 500.0 nm; in a range of about 100.0 nm to about 400.0 nm; in a range of about 200.0 nm to about 500.0 nm). An average length of the NWs (of various compositions) is in a range of about 100.0 μm to about 1000.0 μm (e.g., in a range of about 100.0 μm to about 200.0 μm; in a range of about 150.0 μm to about 500.0 μm; in a range of about 200.0 μm to about 600.0 μm; in a range of about 300.0 μm to about 700.0 μm; in a range of about 500.0 μm to about 800.0 μm; in a range of about 600.0 μm to about 1000.0 μm; in a range of about 150.0 μm to about 800.0 μm; or in a range of about 550.0 μm to about 900.0 μm). An average aspect ratio of the NWs (of various compositions) is in a range of about 1000 to about 1×10⁴ (e.g., in a range of about 1000 to about 2000; in a range of about 1000 to about 3000; in a range of about 2000 to about 5000; in a range of about 3000 to about 7000; in a range of about 5000 to about 1×10⁴; in a range of about 1500 to about 8000; or in a range of about 2000 to about 1×10⁴). Due to considerable flexibility of the AFNW membranes following fluorination, the membranes can be easily produced in a free-standing form, even after being cut into discs, as shown in the inset of FIG. 7A, for use in battery cells. The inset of FIG. 7B shows that a sample thickness of the AFNW membranes is about 12 m. In some implementations, an average thickness of the AFNW membranes is in a range of about 5.0 to about 15.0 m (e.g., in a range of about 5.0 μm to about 10.0 μm; in a range of about 10.0 μm to about 12.0 μm; in a range of about 11.0 μm to about 13.0 μm; in a range of about 12.0 μm to about 14.0 μm; in a range of about 13.0 μm to about 15.0 μm; in a range of about 10.0 μm to about 14.0 μm; in a range of about 11.0 μm to about 15.0 μm; or in a range of about 14.0 μm to about 15.0 μm) by varying the amount of dispersion, as the Al ethoxide NWs are homogeneously dispersed in the alcohol.

FIG. 7C shows TEM images of a sample individual AFNW. The TEM images reveal that the AFNW exhibits a one-dimensional (1D) nanostructure with external pores. This morphology is believed to result from the phase transition and associated stress and volume changes that occur during the transformation of amorphous Al₂O₃ to AlF₃. The inset of FIG. 7C presents a high-resolution TEM micrograph of a sample individual AFNW, where the crystal plane spacing is measured to be approximately 0.35 nm, corresponding to the (012) plane of α-AlF₃.

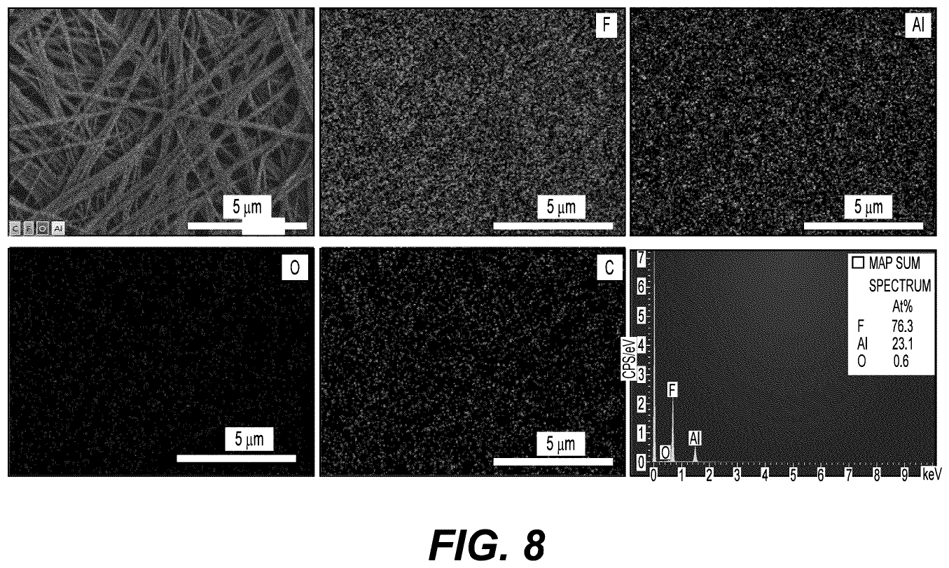

EDS elemental maps and spectra of a sample AFNW membrane, as shown in FIG. 8, reveal an overlapping distribution of fluorine (F) and aluminum (Al) within the NW membrane, with an atomic ratio of approximately 3:1, which is consistent with the expected composition of AlF₃. FIG. 7D shows EDS elemental maps of an individual AFNW obtained from the EDS analysis, indicating the uniform distribution of both Al and F elements within the AFNW.

The phase structure of the AFNWs was confirmed by XRD of an AFNW sample, as shown in FIG. 7E. The XRD spectrum exhibits characteristic peaks at 25.1° and 51.7°, which are indexed to the (012) and (024) planes of α-phase AlF₃ (α-AlF₃, JCPDS #80-1007), respectively. In addition, X-ray photoelectron spectroscopy (XPS) spectra, depicted in FIG. 7F and FIG. 7G, further substantiate the chemical composition of the AFNWs. The F is spectrum in FIG. 7F shows a peak at 687.5 eV, while the Al 2p spectrum in FIG. 7G shows a peak at 76.1 eV; these peaks are attributed to the Al—F bonds in α-AlF₃.

In an initial investigation, the role of the AFNW membrane interlayer in lithium (Li) deposition was evaluated across various electrolyte systems, taking into account the potential effects of electrolyte chemistry on Li deposition and cycling behavior. In some implementations, (1) a commercial carbonate electrolyte comprising 1 M LiPF₆ in ethylene carbonate/diethylene carbonate (EC/DEC=1/1, v/v), (2) an ether-based electrolyte comprising 1 M lithium bis(trifluoromethanesulfonyl) imide (LiTFSI) in dimethoxyethane/dioxolane (DME/DOL=1/1, v/v) with 1 wt. % LiNO₃ additive, or (3) an ether-based, localized high-concentration electrolyte (LHCE) comprising 1.5 M lithium bis(fluorosulfonyl)imide (LiFSI) in DME diluted by 1,1,2,2-tetrafluoroethyl 2,2,3,3-tetrafluoropropyl ether (TTE) (DME/TTE=1.2/3, by molar ratio) is used in the context of the present disclosure.

For electrolyte (2) above, 1 M Lithium bis(trifluoromethanesulfonyl) imide (LITFSI, SIGMA ALDRICH®, 99.95%) was dissolved in a mixture of 1,2-Dimethoxyethane (DME, SIGMA ALDRICH®, 99.8%) and 1,3-dioxolane (DOL, SIGMA ALDRICH®, 99.8%) with a volume ratio of 1:1, and then 1 wt. % LiNO₃ (ALFA AESAR, 99%) was added to the solution. Electrolyte (3): the localized high concentration electrolyte (LHCE) was prepared by dissolving lithium bis(fluorosulfonyl)imide (LiFSI, TCI, 98%) in DME for stirring overnight to form a clear solution, adding 1,1,2,2-Tetrafluroethyl 2,2,3,3-Tetrafluoripropyl Ether (TCI, 95%), and stirring for another 12 h. All the chemicals were dried overnight under an argon atmosphere before formulating the specific electrolyte compositions. Electrolyte (1): A commercial electrolyte of 1 M lithium hexafluorophosphate (LiPF₆) in ethylene carbonate/diethylene carbonate (EC/DEC=50/50, v/v) was purchased from SIGMA ALDRICH® (USA).

In some implementations, Li∥Cu half cells, Li∥Li symmetric cells and Li metal full cells were assembled into a CR2032 coin type in an Ar-filled glovebox (H₂O<0.02 ppm, O₂<0.1 ppm) to study electrochemical performance. A porous polypropylene monolayer membrane (Celgard 2075, thickness ˜20 m) was used as the separator. For Li∥Cu cells with an AFNW interlayer, the AFNW disc with a size (diameter) of 13 mm was placed between the Cu foil and the separator and a piece of Li foil was used as the counter/reference electrode. About 75 μl of electrolyte is used for each Li∥Cu cell. For Li∥Li symmetric cells, Li of areal capacity of 3 mAh cm⁻² is plated onto the Cu foils of each of the Li∥Cu cells at a current density of 0.5 mA cm⁻². Then two Li∥Cu cells were opened in the glove box and the Cu foils with plated Li were taken out for the assembling of a Li∥Li symmetrical cell. Li metal full cells were assembled using a commercial single-coated LiFePO₄ (LFP, active mass loading ˜7.66 mg cm⁻² (NEI® Corp.) or a commercial single-coated LiNi_{0.8}Co_{0.1}Mn_{0.1}O₂(NCM811, active mass loading 10.02 mg cm⁻², NEI® Corp.) cathode. To assemble Li metal full cells with a specific N/P ratio, Li was first deposited on Cu with and without an AFNW membrane in Li∥Cu cells to approximate the desired anode capacity as determined by the specific N/P ratio and the cathode capacity. The Li∥Cu cells were first discharged to 0.05 V and held for 20 h for the formation of LiF. To prevent the corrosion from 1 M LiFSI/DME/TTE electrolyte, Al-clad cases were used for NCM811 coin cells.

In some examples, electrochemical tests were conducted on a multichannel Arbin testing system (ARBIN INSTRUMENTS®, USA) at room temperature (−20° C.). The Li∥Cu cells were tested by plating at different current densities for a capacity of 1 mAh cm⁻² and stripping at the current density to 1.2 V. The plating/stripping performance of Li∥Li symmetrical cells was tested at 1 mA cm⁻² for 1 h. The Li∥LFP full cells were cycled in a voltage range of 2.5-3.9 V at 0.5 C (first 2 cycles at 0.2 C, 1 C=170 mA g⁻¹). The Li∥NCM811 full cells were cycled at 0.5 C (first 2 cycles at 0.2 C, 1 C=190 mA g⁻¹) in a voltage range of 2.8-4.4 V. The anode-free Cu∥NCM811 cells were charged at 0.2 C and discharged at 0.5 C in a voltage range of 2.8-4.4 V. The average coulombic efficiency (CE) tests were conducted in Li∥Cu cells. A formation cycle was applied by plating at a current density of 0.5 mA cm⁻² for 10 h and stripping to 1.2 V. With 5 mAh cm⁻² of Li deposited at a current density of 0.5 mA cm², the cells were then stripped/plated at a current density of 1 mA cm⁻² to an areal capacity of 1 mAh cm⁻² h for the subsequent 10 cycles and finally stripped back to 1.2 V at a current density of 0.5 mA cm².

In some examples, sample cells that had undergone Li deposition were disassembled and characterized to understand the details of Li deposition. After Li deposition, the cells were disassembled. The Li—Cu electrodes (Cu current collector with deposited Li, or Cu current collector covered with AFNW and deposited Li) were washed by the corresponding electrolyte solvent and dried in a glovebox (20 minutes or more) for subsequent characterizations. For example, samples were transferred to the XPS apparatus with a vacuum transfer holder to minimize air exposure. The surface charging is compensated for by a flood gun.

In some examples, Li∥Cu cells incorporating an AFNW interlayer disposed on and/or in a current collector of Cu were first discharged to a voltage of 0.05 V (vs. Li/Li⁺) and held at this potential for 20 hours prior to initiating Li deposition. This procedure allowed the AFNW interlayer to generate an in situ LiF-rich interphase at the AFNW/Cu contact interface via a conversion reaction, as represented by Formula 1:

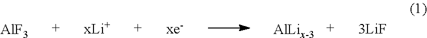

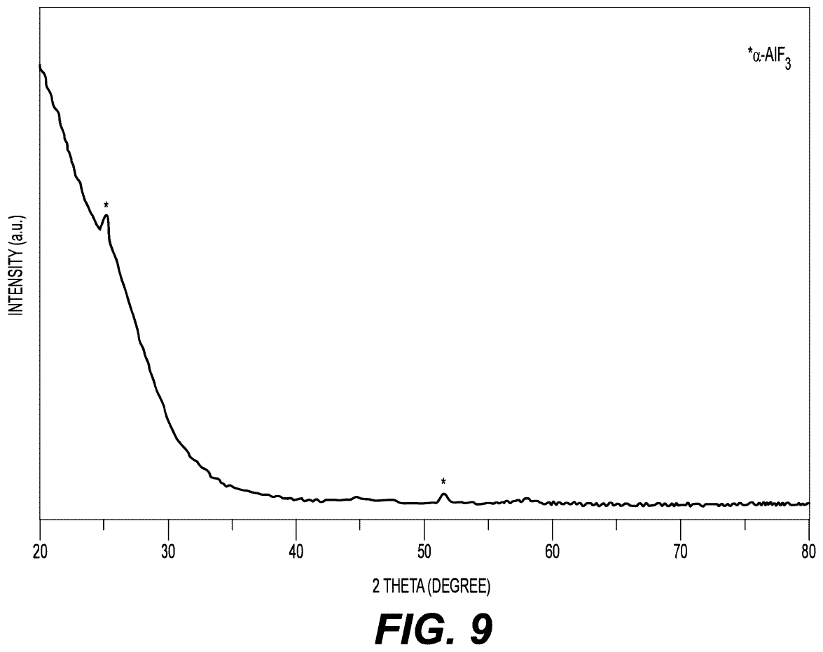

The initial conversion reaction was observed to occur exclusively at the surface of the AFNW layer in contact with the Cu current collector, with no significant structural alteration of the AFNW membrane. The XRD spectrum of the AFNW interlayer (after initial conversion reaction), as shown in FIG. 9, exhibits characteristic peaks at 25.1° and 51.7, which are indexed to the (012) and (024) planes of α-phase AlF₃ (α-AlF₃, JCPDS #80-1007), respectively. These XRD diffraction peaks reveal that the AFNW retained a strong α-AlF₃ phase intensity, consistent with a minimal amount of in-situ LiF formation.

For comparison, Li∥Cu cells without the AFNW interlayer undergo the same process of first being discharged to a voltage of 0.05 V (vs. Li/Li⁺) and held at this potential for 20 hours prior to initiating Li deposition.

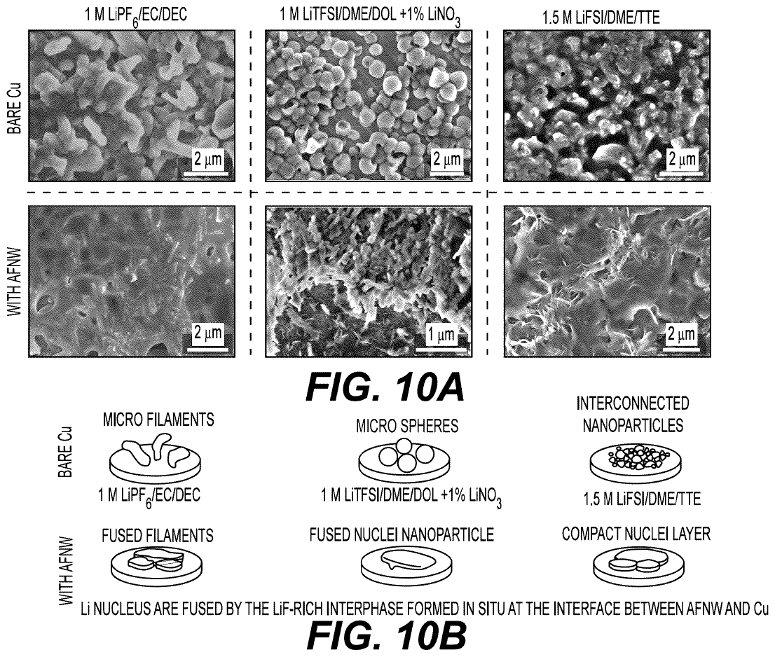

As schematically illustrated in FIG. 6B, the initial lithium (Li) nucleation process was studied by applying a moderate current density of 1 mA cm⁻² to deposit a limited quantity of Li (to an areal capacity of 0.1 mAh cm⁻²) on bare Cu or over the AFNW interlayer deposited on Cu within a coin cell configuration, with no additional mechanical pressure applied during the process. FIG. 10B schematically illustrates the nucleation morphology of Li on the Cu substrate under the three distinct electrolyte systems to determine how electrolyte composition impacts Li nucleation structure and the properties of the solid electrolyte interphase (SEI).

Experimental results reveal significant morphological differences in Li nuclei between among substrates and electrolyte compositions. As illustrated in FIG. 10A, on the bare Cu substrate (without AFNW), Li nuclei exhibit distinct structures: micro-filaments form in a 1 M LiPF₆ in ethylene carbonate (EC) and diethyl carbonate (DEC) solution, micro-spheres emerge in a 1 M LiTFSI in dimethoxyethane (DME) and 1,3-dioxolane (DOL) solution with 1 wt. % lithium nitrate (LiNO₃), and interconnected nanoparticles are observed in a 1.5 M LiFSI in DME and TTE solution. The different electrolyte chemistries not only influence the nucleation morphologies of Li but also alter the composition of the SEI formed on the Cu surface.

It was observed that the bare Cu substrate, characterized by a lithiophobic surface, lacks active nucleation sites, which results in poor contact with Li nuclei. Conversely, Li nucleation over the AFNW interlayer shows a uniform, dense morphology across all electrolyte systems. The in-situ formation of a LiF/AlLiₓ-based interphase layer over the AFNW interlayer acts as active nucleation seeds, promoting the formation of a uniform, compact Li layer with a stable SEI.

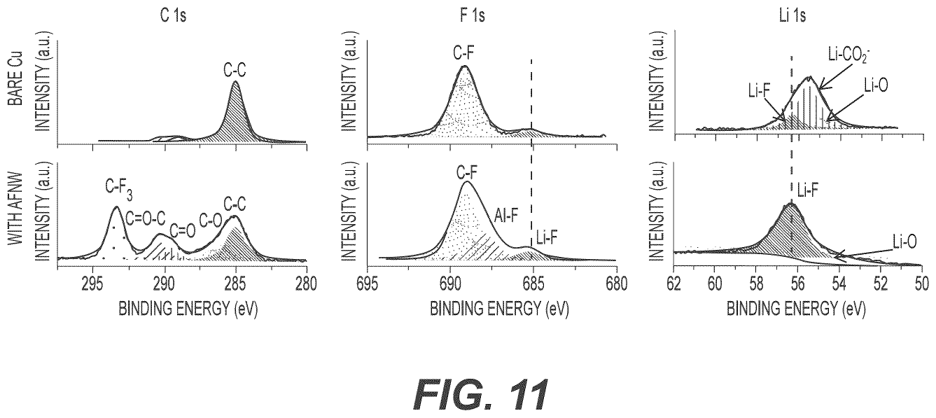

Further investigation into the SEI chemical composition was conducted via X-ray photoelectron spectroscopy (XPS) on the Li nucleated both on bare Cu and on Cu with the AFNW interlayer. XPS spectra of C 1s, F 1s, and Li is signals, as illustrated in FIG. 11, were obtained from the surface of Li nuclei formed on bare Cu and beneath the AFNW interlayer in sample Li∥Cu cells to analyze the chemical composition of the SET. The C is spectrum with the AFNW interlayer shows enhanced peaks corresponding to C—F₃, C═O—C, C═O, and C—O bonds, indicating a significant organic SEI formation from electrolyte decomposition. Additionally, the F is and Li is spectra reveal elevated intensities for Li—F bonds with the AFNW layer, suggesting the presence of an in-situ formed LiF-rich interphase beneath the AFNW interlayer.

These findings advance the understanding of fundamental Li nucleation mechanisms and highlight the advantages of AFNW interlayer in regulating Li nucleation behavior. By providing active nucleation sites, AFNW interlayers facilitate uniform Li growth, which may help suppress dendritic Li growth. The data suggests that incorporating AFNW into Li metal cells is an effective strategy to regulate Li nucleation morphology and SEI composition across various electrolyte chemistries.

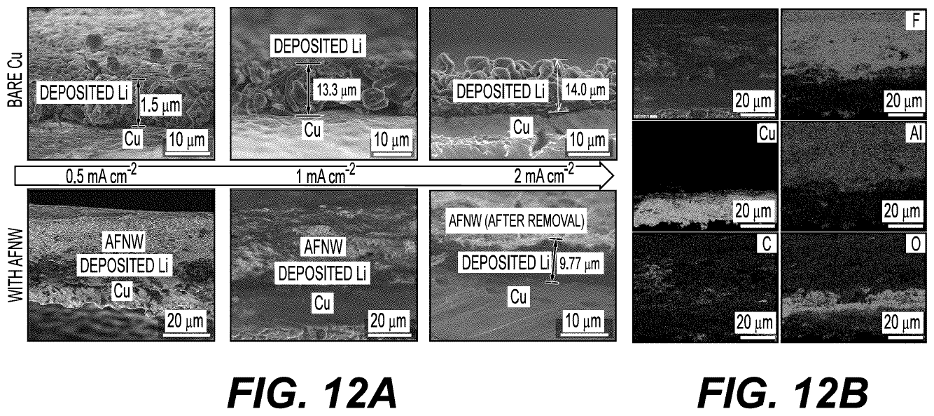

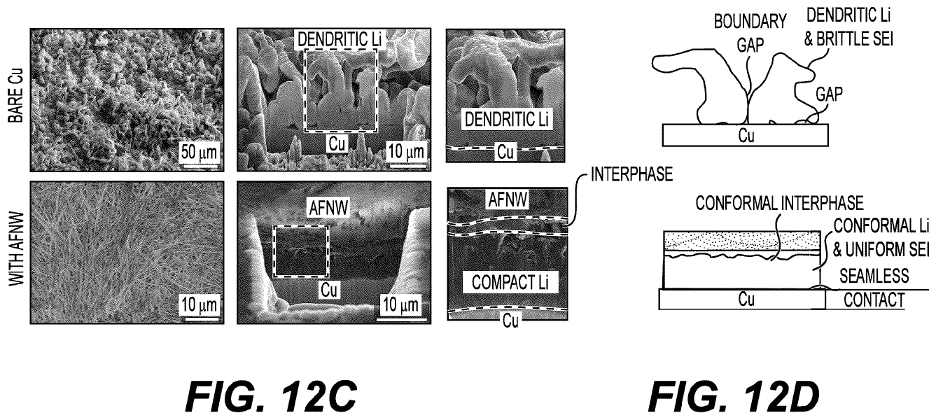

Lithium (Li) growth with and without the AFNW interlayer was investigated by depositing additional Li onto Cu without applying any external mechanical pressure to the coin cells. For comparative analysis, various current densities were employed to deposit Li, achieving a total areal capacity of 1 mAh cm⁻². As shown in cross-sectional SEM images in FIG. 12A, the deposited Li on bare Cu exhibits a mossy microstructure indicative of dendritic growth. The deposition layer thickness was measured at approximately 11.5 μm, 12.3 μm, and 14.1 μm for current densities of 0.5 mA cm⁻², 1 mA cm⁻², and 2 mA cm², respectively.

In contrast, when the AFNW interlayer is present, a uniform, compact layer of deposited Li forms between the AFNW interlayer and the Cu substrate at each current density (0.5 mA cm⁻², 1 mA cm⁻², and 2 mA cm⁻²). Determining the precise thickness of the Li layer beneath the AFNW, however, is challenging due to the in-situ formation of a LiF/AlLiₓ interphase. This interphase exhibits strong lithiophilic properties, causing the Li layer to fuse with both the AFNW and the Cu substrate. To accurately assess the Li deposition, the AFNW interlayer was carefully removed before SEM observation. Under a plating current density of 2 mA cm⁻², a compact Li layer with a thickness of approximately 9.8 μm was observed, as depicted in FIG. 12A. This layer is approximately 30% thinner than the Li layer on bare Cu.

The theoretical thickness of Li deposition is approximately 4.85 μm per mAh cm⁻². Based on this, the porosity of the Li layer deposited over the AFNW interlayer is calculated to be about 51.5%, which is notably lower than the 65.6% porosity observed on bare Cu. This dense and uniform deposition layer is direct evidence of the regulatory effect that the AFNW interlayer exerts on Li deposition.

FIG. 12B displays EDS elemental maps of the cross-sectional layers in the AFNW/Li/Cu stack deposited at a current density of 1 mA cm⁻² over one hour. The presence of F and Al elements in the uppermost layer confirms that the AFNW interlayer is primarily composed of AlF₃. This composition contributes to a LiF-rich interphase that stabilizes both the Li metal and the solid electrolyte interphase (SEI), thereby enhancing the electrode's capacity for higher Li plating and/or extended cycling.

It is also notable that the elemental maps for F, C, and O exhibit overlap in an intermediate layer connecting the AFNW interlay and Cu. This overlap is indicative of a composite SEI layer, comprising an in-situ LiF-rich interphase from the AFNW interlayer, organic SEI components derived from electrolyte decomposition, and minor surface-oxidized Li.

To further elucidate the structural characteristics of the deposited Li, FIB-SEM was utilized to examine the AFNW/deposited-Li/Cu sandwiched layers. Top-view images acquired prior to ion milling, as shown in the left column of FIG. 12C, illustrate the differing deposition behaviors of Li on substrates with and without the AFNW interlayer at a current density of 1 mA cm⁻² and a total areal capacity of 1 mAh cm⁻². On bare Cu, Li forms mossy structures, whereas the sample with AFNW results in a flat Li surface.

After ion milling, the layered structure reveals a dense Li layer beneath the AFNW interlayer, contrasting with the porous, dendritic Li structure observed on bare Cu (middle column of FIG. 12C), which aligns with the cross-sectional SEM images presented in FIG. 12A. Higher-magnification images in the right column of FIG. 12C further highlight the distinctions in deposited Li morphology on bare Cu versus beneath the AFNW interlayer, as schematically illustrated in FIG. 12D. On bare Cu, the Li layer consists of isolated dendritic formations, with significant boundary gaps between them and prominent seams or voids between the deposited Li and the Cu substrate. These gaps and voids result from the lithiophobic nature of the Cu surface, which impedes effective Li nucleation and bonding.

Conversely, the AFNW regulates Li deposition to form a uniform, compact layer. The transition layer between the AFNW interlayer and the deposited Li, likely an in-situ-formed LiF-rich interphase with lithophilic properties, stabilizes the Li metal and promotes seamless contact with the Cu substrate. This lithophilic interphase facilitates a more stable and cohesive Li deposition structure, enhancing substrate adhesion and layer integrity.

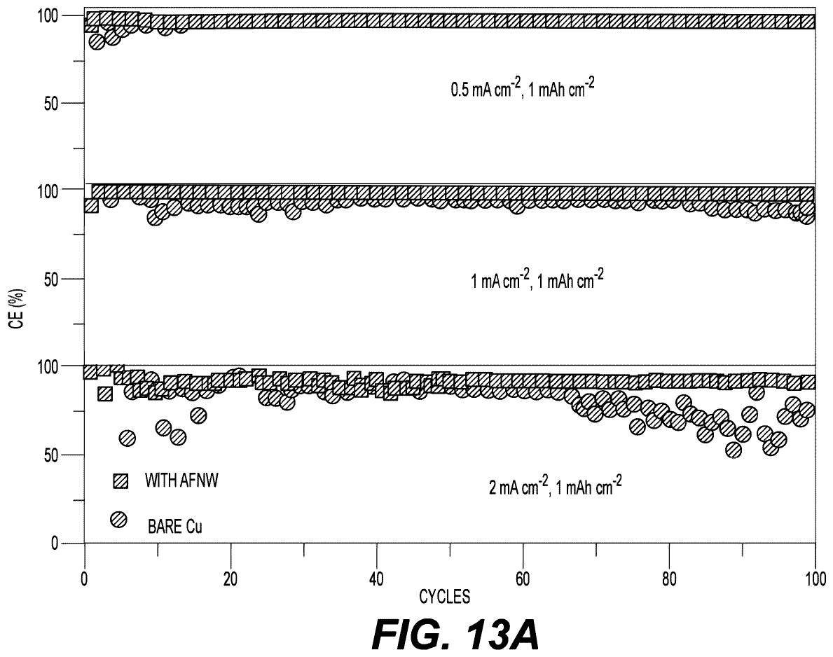

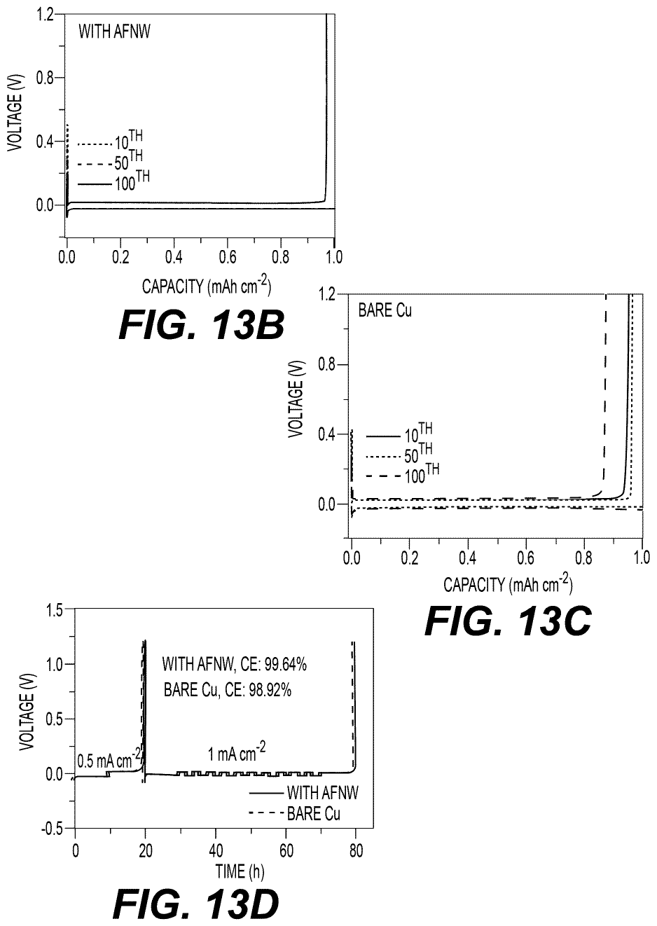

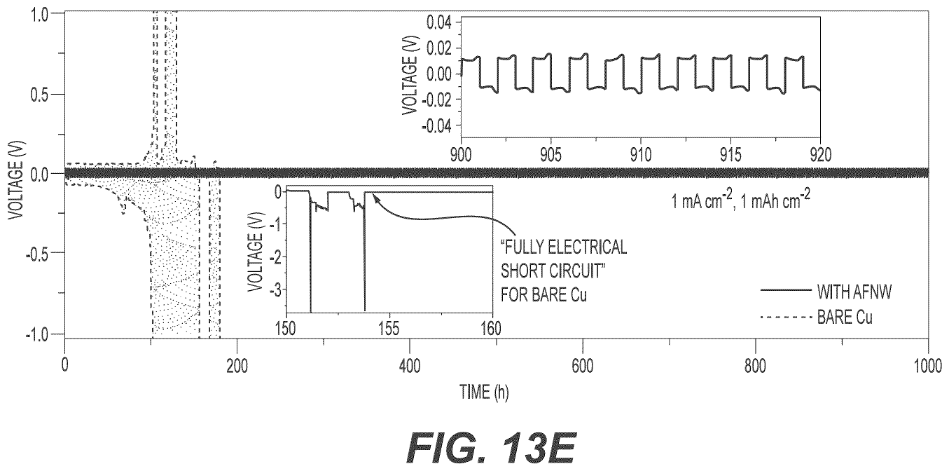

To examine Li plating and stripping behavior and the associated coulombic efficiency (CE), defined as the ratio of stripped capacity to plated capacity, Li∥Cu half cells and Li∥Li symmetric cells were assembled. In the Li∥Cu cells, a constant plating capacity of 1 mAh cm⁻² was applied during plating and stripping cycles at various current densities. FIG. 13A presents a comparison of the Coulombic Efficiencies (CE) of sample cells equipped with bare Cu and with the AFNW interlayer. It is observed that AFNW outperforms bare Cu under all tested current densities, ranging from 0.5 to 2 mA cm⁻².

At a low current density of 0.5 mA cm⁻², the cell utilizing AFNW achieves a stable CE of approximately 97.5% on average, compared with an average of 96.6% for the cell with bare Cu. At a moderate current density of 1 mA cm⁻², the AFNW cell maintains an average CE of around 97.2%, whereas the cell with bare Cu only reaches an average of approximately 94.2%. At a high current density of 2 mA cm⁻², the AFNW cell demonstrates a stable average CE of around 91.2%, significantly surpassing the average CE of bare Cu, which is only approximately 81.4%. Compared to cells with bare Cu, those incorporating AFNW display markedly improved Coulombic Efficiencies over successive cycles.

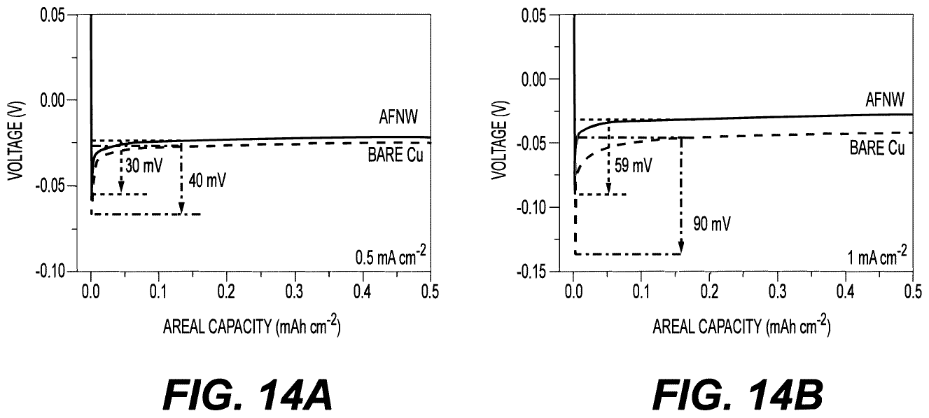

The nucleation overpotential serves as an important metric for assessing the energy required for metallic lithium (Li) nucleation and growth during discharge, a process described by classical nucleation and growth theory. As depicted in FIG. 14A and FIG. 14B, the nucleation overpotentials for Li over AFNW are significantly lower, measuring 30 mV at 0.5 mA cm⁻² (FIG. 14A) and 59 mV at 1 mA cm⁻² (FIG. 14B), in contrast to bare Cu, which shows nucleation overpotentials of 40 mV at 0.5 mA cm⁻² (FIG. 14A) and 90 mV at 1 mA cm⁻² (FIG. 14B). These results indicate that the diffusion barrier for Li nucleation and growth over AFNW is notably reduced, which is attributable to the low adatom surface diffusion barrier following the formation of a LiF interface between the AFNW interlayer and Cu substrate. The controlled Li nucleation process facilitated by AFNW further results in a reduced cycling overpotential, as demonstrated in FIGS. 13B and 13C (compare FIG. 13B for cell with AFNW interlayer on Cu current collector to FIG. 13C for cell with bare Cu current collector).

As the Coulombic Efficiency (CE) of Li metal cells varies with electrolyte composition and current density, the presence of AFNW supports an improvement in CE. Notably, achieving 100% CE is impractical in half-cell testing due to the unavoidable Li loss associated with SEI formation and side reactions. To further investigate Li plating and stripping behavior in Li∥Cu cells, CE measurements were implemented with a formation cycle prior to cycling. Average CE values were determined by comparing the amount of Li stripped at the cycle's end with the plated amount after the formation cycle, as shown in FIG. 13D. The calculated average CE of the Li∥Cu cell with AFNW is significantly higher, reaching 99.64%, compared to the bare Cu cell's average CE of 98.92%. These findings underscore the potential of AFNW to effectively stabilize the Li metal anode.

To further assess the performance of Li plating and stripping, Li∥Li symmetric cells were assembled with a Li capacity of 3 mAh cm⁻² deposited beneath an AFNW interlayer or on bare Cu, serving as electrodes on both sides. FIG. 13E compares the long-term cycling performance of these symmetric cells at a current density of 1 mA cm⁻² for an areal capacity of 1 mAh cm⁻² in a 1 M LiTFSI-based electrolyte. With the AFNW interlayer, the cell demonstrates stable plating and stripping behavior for over 1000 hours, maintaining a remarkably low overpotential of approximately 10 mV after 900 hours. This low overpotential indicates minimal chemical resistance during cycling, thereby validating the enhanced stability provided by AFNW, which protects the Li metal anode from dendrite formation and the development of inactive (“dead”) Li.

In contrast, the cell with bare Cu shows a sharp increase in overpotential after 100 hours, followed by complete electrical short-circuit failure within 150 hours. This degradation is primarily attributed to dendrite growth, which disrupts the fragile SEI, produces dead Li, and ultimately punctures the separator.

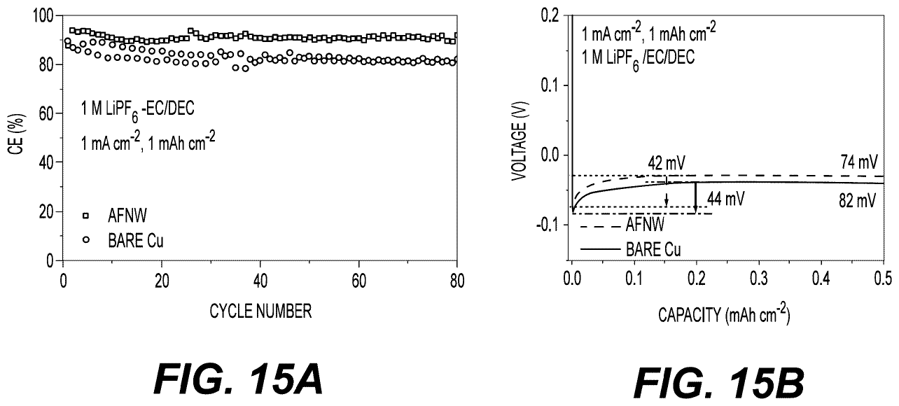

These results demonstrate the superior performance of AFNW interlayer within the standard ether electrolyte system. Additionally, the regulatory effect of AFNW interlayer on Li plating and stripping behaviors was also observed across other electrolyte systems, including a conventional carbonate electrolyte (1M LiPF₆/EC/DEC) and a state-of-the-art local high-concentration electrolyte (LHCE) system (1.5 M LiFSI/DME/TTE). The application of AFNW significantly enhances CEs with a relatively low overpotential in the 1M LiPF₆/EC/DEC electrolyte, as shown in FIG. 15A and FIG. 15B, respectively.

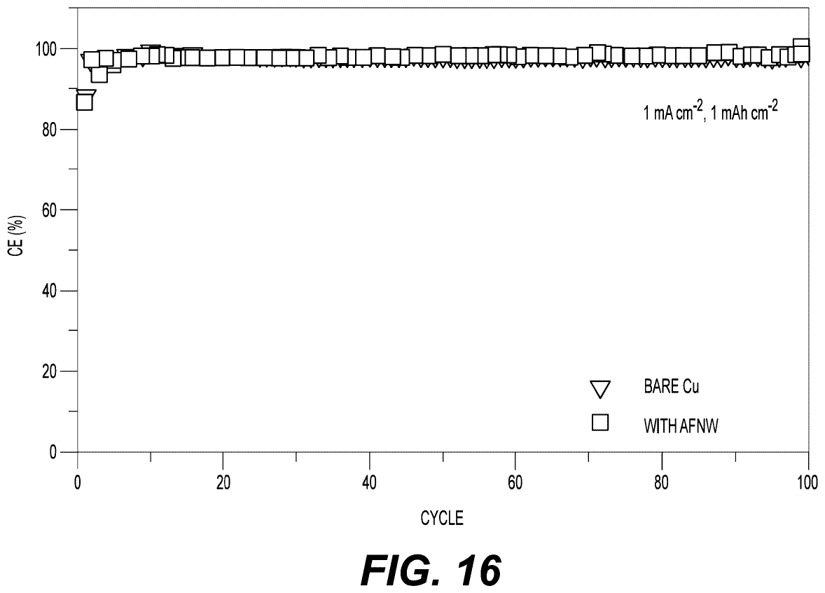

In the 1.5 M LiFSI/DME/TTE electrolyte, the cells exhibit notably improved cycling performance with high CEs, as illustrated in FIG. 16. Overall, the integration of AFNW effectively enhances Li plating and stripping across all three electrolyte systems, indicating that the AFNW approach is highly versatile and could potentially be broadly applied to various Li metal systems, and potentially even to sodium (Na) metal systems.

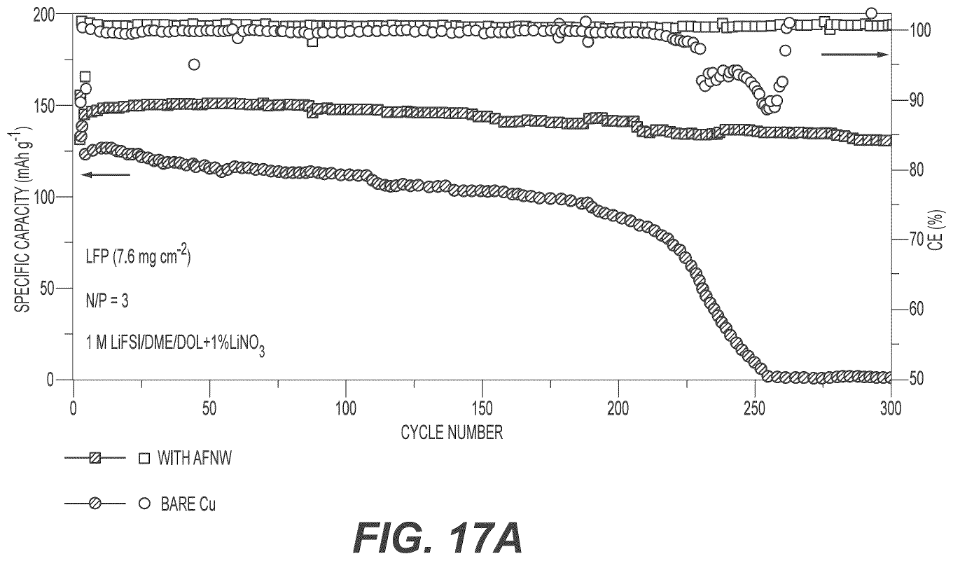

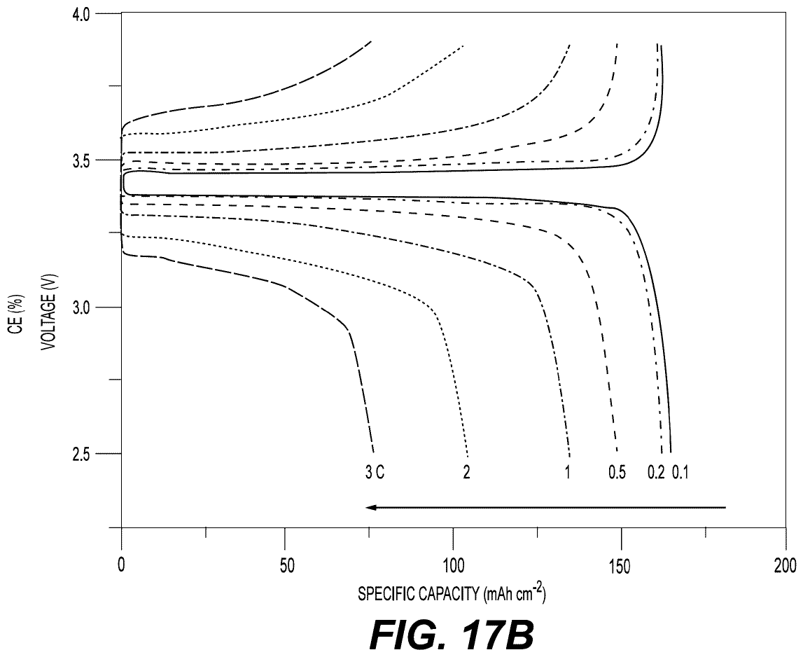

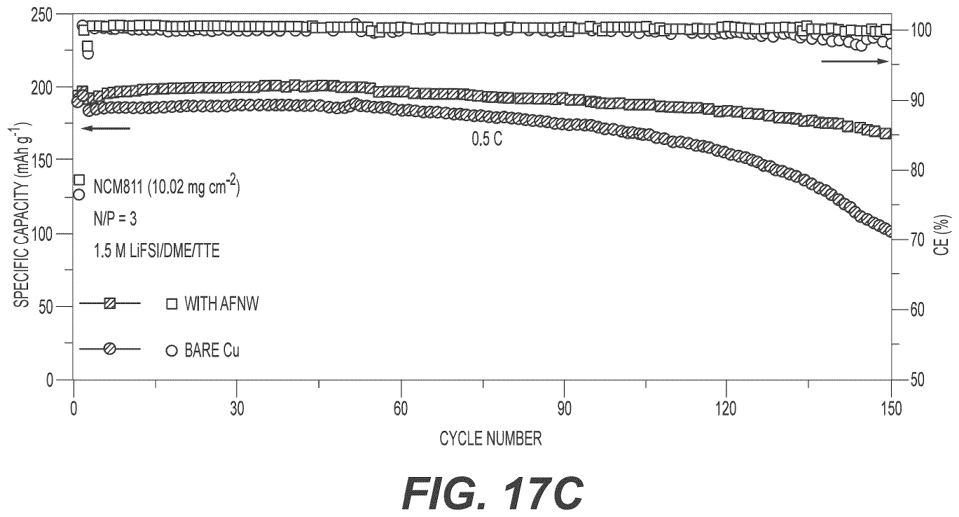

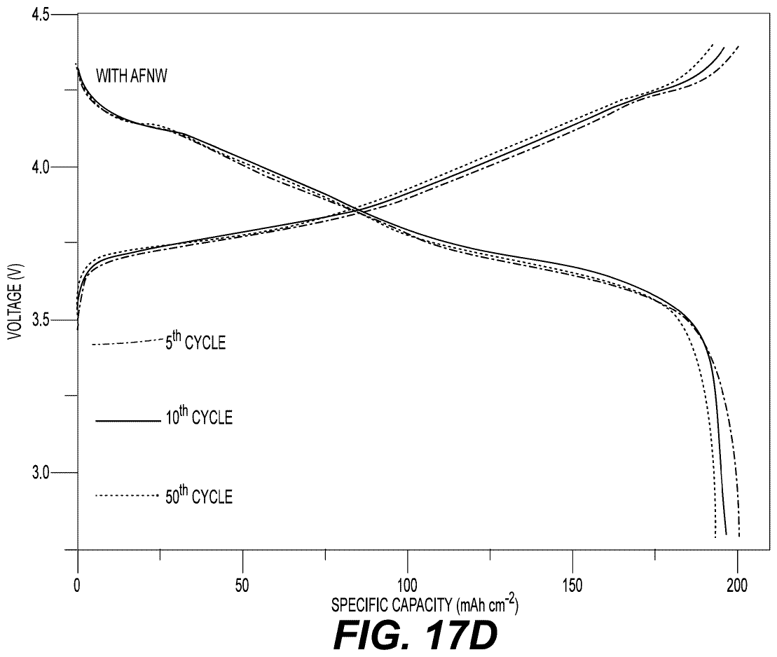

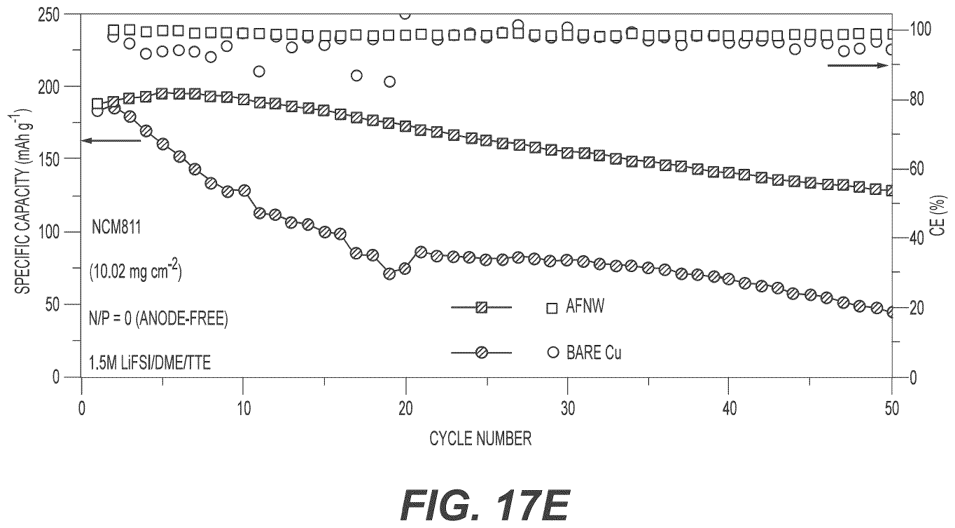

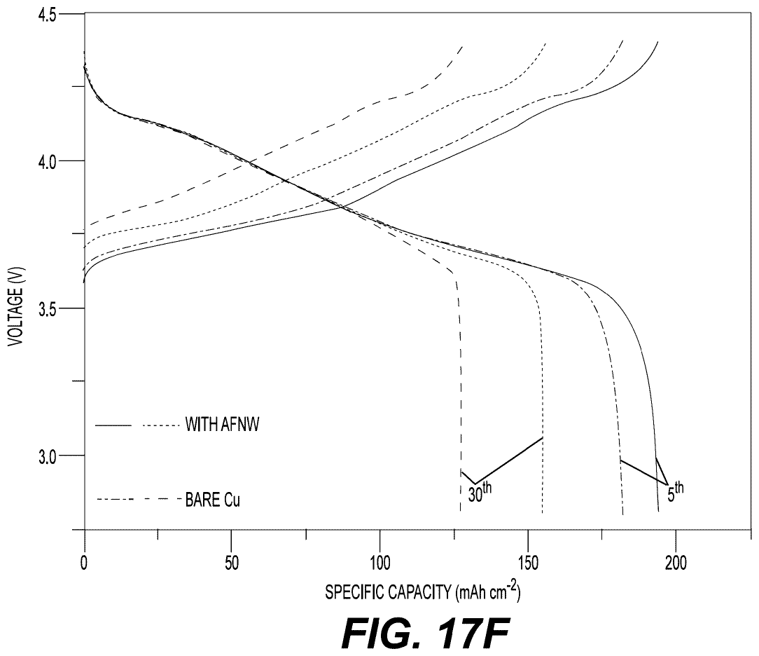

To assess the performance of AFNW in Li metal full cells, which require Li plating on the anode to achieve a reasonable areal capacity that matches commercial cathode loadings, Li metal full cells were constructed with pre-deposited Li on Cu (with or without AFNW interlayer) as the anode and paired with either a LiFePO₄ (LFP, mass loading ˜7.66 mg cm⁻²) or LiNi_{0.8}Co_{0.1}Mn_{0.1}O₂ (NCM811, mass loading ˜10.02 mg cm⁻²) cathode. Initially, Li∥LFP full cells with varying negative-to-positive (N/P) ratios were evaluated in a 1 M LiTFSI/DME/DOL+1% LiNO₃ electrolyte. FIG. 17A compares the cycling performance of the cells based on AFNW interlayer and bare Cu with 2× excess Li (N/P=3) at a charge/discharge rate of 0.5 C (1 C=170 mAh g⁻¹) for 300 cycles, excluding the first two cycles performed at 0.1 C.

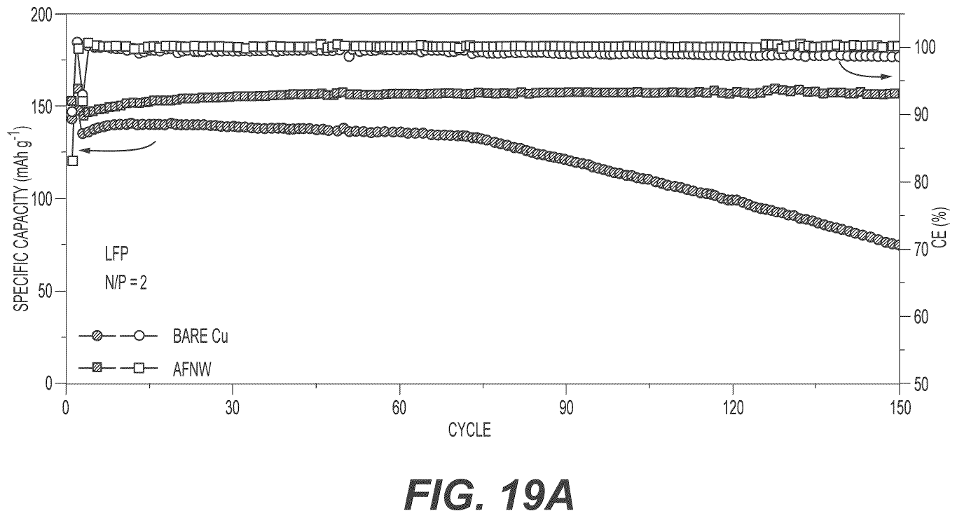

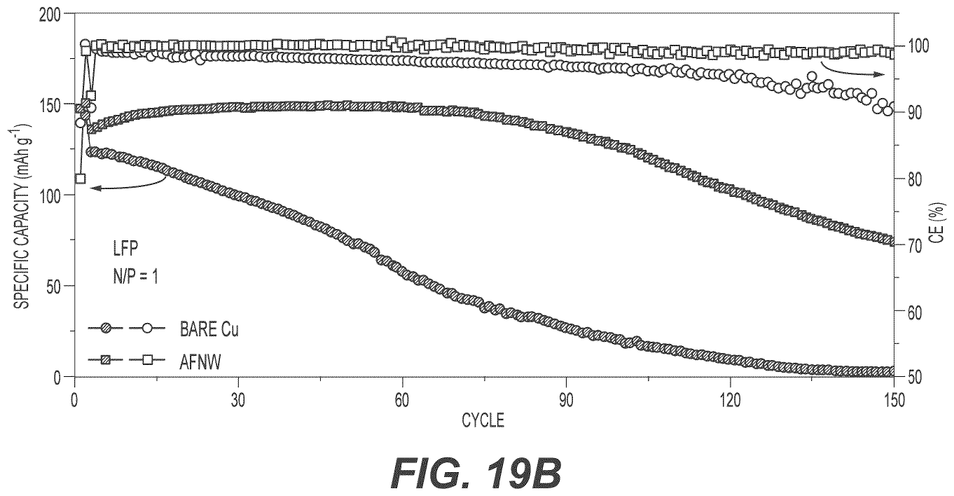

In FIGS. 17A, 17C, 17E, 19A and 19B, the left arrows indicate that the solid symbol data points are associated with the specific capacity on the left y-axis, while the right arrows indicate that the open symbol data points are associated with the coulombic efficiency (CE) on the right y-axis.

The cells incorporating AFNW interlayer demonstrate significantly better cycle stability and higher CEs than the cells with bare Cu (FIG. 17A). The AFNW-based cells exhibit a slightly higher initial capacity (144 mAh g⁻¹ in the third cycle) compared to the bare Cu cells (˜124 mAh g⁻¹). After 300 cycles, the AFNW-comprising cell maintains a specific capacity exceeding 131 mAh g⁻¹, corresponding to a capacity retention of 91%, with high average CEs (˜100%). In contrast, the bare Cu-based cells experience rapid capacity degradation and fluctuating CEs throughout cycling.

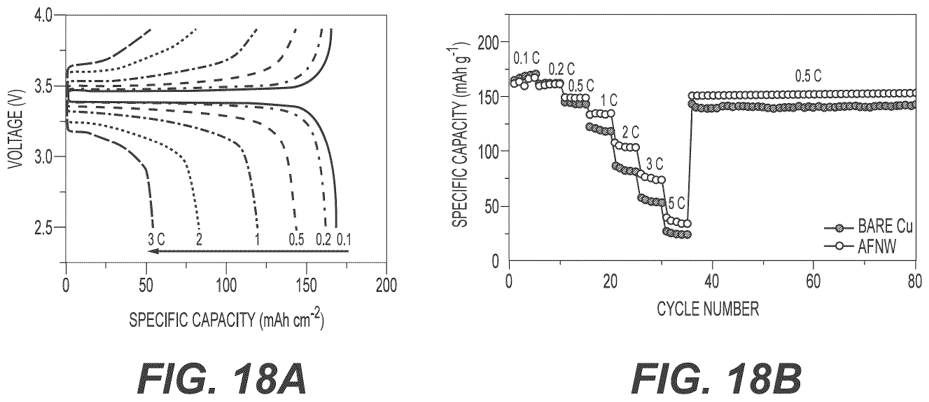

The rate performance of the AFNW-based cells (N/P=3) as shown in FIG. 17B demonstrates superior rate capability and lower voltage hysteresis than the bare Cu cell as shown in FIG. 18A, particularly at high rates (about 1 C-about 3 C), indicating enhanced rechargeability. Upon returning to a 0.5 C rate, the AFNW-based cell maintains stable and high specific capacities as shown in FIG. 18B, further confirming that AFNW stabilizes the Li metal anode. Li∥LFP cells with a lower N/P ratio are also evaluated, where the cells with AFNW interlayer exhibited significantly better cycling performance and higher CEs compared to bare Cu cells, as shown in FIG. 19A and FIG. 19B. For N/P=2, the cells with AFNW interlayer and bare Cu exhibited capacity retention of 108% and 56%, respectively, after 150 cycles. When the N/P ratio was reduced to 1, the AFNW-based cells maintained 54% of their initial capacity after 150 cycles, whereas the bare Cu cells rapidly degraded to nearly zero capacity.

NCM811 generally offers a higher specific energy and areal capacity than LFP, but it is also associated with a shorter cycle life. To evaluate the performance of AFNW in NCM811-based cells, full cells were assembled using high-loading NCM811 (˜10 mg cm⁻²) cathodes paired with either a limited-excess Li anode or an anode-free configuration. The cells with 2× excess Li (N/P=3) were cycled in a 1.5 M LiFSI/DME/TTE electrolyte within a voltage range of 2.8-4.4 V at a charge/discharge rate of 0.5 C (with the exception of the first two cycles performed at 0.2 C, where 1 C=190 mAh g 1).

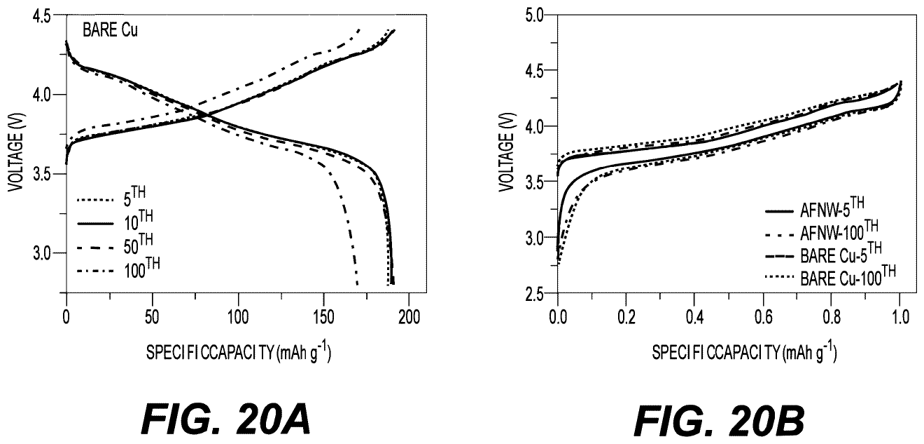

As illustrated in FIG. 17C, the cells with AFNW demonstrate consistently superior performance compared to those with bare Cu. After 150 cycles, the AFNW-based cells retain a capacity of 167.9 mAh g⁻¹ (corresponding to an areal capacity of ˜1.68 mAh cm⁻²), in contrast to the bare Cu-based cells, which exhibit a capacity of 101.4 mAh g⁻¹ (approximately ˜1.02 mAh cm⁻²). Charge-discharge voltage profiles presented in FIG. 17D (with an AFNW interlayer) and FIG. 20A (bare Cu) further confirm that the cells with an AFNW interlayer exhibit significantly lower voltage hysteresis compared to those with bare Cu, indicating improved cycling stability and energy efficiency.

Building upon the promising results observed with NCM811, the functionality of an AFNW interlayer was further investigated in anode-free cells (Cu∥NCM811) without pre-deposited Li. The cells were cycled with a 0.2 C charge followed by a 0.5 C discharge at room temperature (20° C.), as operation under ambient conditions may be more practical for real-world applications. As shown in FIG. 17E, the cell with an AFNW interlayer demonstrated a stable initial capacity of 180 mAh g⁻¹ and retained 72% of its capacity after 50 cycles. In contrast, the cell with bare Cu exhibited a much faster capacity decay, reaching the same capacity retention after only 10 cycles. Voltage profiles presented in FIG. 17F indicate that the incorporation of an AFNW interlayer significantly reduces voltage hysteresis during cycling, highlighting its effectiveness in improving the cycling performance and efficiency of anode-free cells.

The promising electrochemical performance observed may be attributed to the use of the AFNW interlayer, which regulates lithium deposition and enhances lithium plating/stripping performance. In the absence of such an interlayer (bare Cu), the formation of inactive “dead” lithium significantly limits the reversibility of the plating/stripping process. Additionally, the incorporation of AFNW interlayers in lithium cells can provide a physical enhancement to safety, particularly in the event of short circuits and thermal runaway. This is due to the inorganic properties of AlF₃, including its high Young's modulus and superior thermal stability. These attributes underscore some of the advantages of the interlayer strategy in improving both the electrochemical and safety performance of lithium metal batteries.

Additional details that relate to the aspects and embodiments described herein are described and illustrated in U.S. Provisional Application No. 63/601,464, entitled “FREE-STANDING CONVERSION INTERLAYER FOR STABLE LITHIUM METAL BATTERIES,” and attached hereto, the contents of which are expressly incorporated herein by reference in their entirety as part of this disclosure.

Battery cell modules or battery cell packs may advantageously comprise cells with anode-interlayer component, cathode electrodes, separators and/or electrolyte compositions provided in this disclosure. Such cell modules or packs may offer improved performance characteristics, simplified designs, better safety features, and/or lower cost.

By way of example, the disclosed herein batteries can be advantageously used in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, air taxi, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least about 10, at least about 100, at least about 500 batteries of the present disclosure. Batteries in multi-cell batteries may be arranged in parallel or in series.

While the foregoing description has provided details on the use of AlF₃ nanowires and nanoparticles (including elongate nanoparticles) as an interlayer in batteries, AlF₃ nanomaterials may be employed in other applications. AlF₃ nanomaterials may be used as a catalyst material: AlF₃ works as a strong Lewis acid catalyst. High-surface area AlF₃ (e.g., porous AlF₃ nanowires and nanoparticles) can be used as a catalyst for CHClF₂ dismutation and CBrF₂CBrFCF₃ isomerization reactions. AlF₃ nanomaterials may be used as an additive for glasses: AlF₃-based glasses show improved chemical durability and enhanced mechanical strength. AlF₃ may be used for (far) ultraviolet reflectance: AlF₃ is a low refractive index material with promising optical applications for ultraviolet (UV) wavelengths. AlF₃ can be used as a coating material to stabilize far UV (FUV) glasses or Al mirrors for astronomy applications.

In the detailed description above, it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause is not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1. A nanowire composition, comprising: nanowires comprising aluminum fluoride (AlF₃).
Clause 2. The nanowire composition of clause 1, wherein: the AlF₃ comprises α-phase AlF₃.
Clause 3. The nanowire composition of any of clauses 1 to 2, wherein: the nanowires are porous and comprise external pores.
Clause 4. The nanowire composition of any of clauses 1 to 3, wherein: an average diameter of the nanowires is in a range of about 100 to about 500 nm.
Clause 5. The nanowire composition of any of clauses 1 to 4, wherein: an average length of the nanowires is in a range of about 100 to about 1000 μm.
Clause 6. The nanowire composition of any of clauses 1 to 5, wherein: an average aspect ratio of the nanowires is in a range of about 1000 to 1×10⁴.
Clause 7. A membrane, comprising: the nanowire composition of Clause 1.
Clause 8. The membrane of clause 7, wherein: the membrane comprises a nonwoven network of the nanowires.
Clause 9. An anode-interlayer component, comprising: an anode; and an interlayer disposed on the anode, wherein: the interlayer comprises the nanowire composition of Clause 1; and the interlayer is in the form of a membrane or a coating.
Clause 10. The anode-interlayer component of clause 9, wherein: the anode comprises one or more of the following in direct contact with the interlayer: Li metal, a current collector, or composite particles comprising carbon and silicon.
Clause 11. The anode-interlayer component of clause 10, wherein: the anode comprises the current collector; and the current collector comprises Cu, Al, Ni, Ti, Mo, Fe, steel, a graphene coating, a carbon coating or film, carbon nanotubes, and/or carbon nanofibers.
Clause 12. A lithium-ion battery, comprising: a cathode; the anode-interlayer component of Clause 10; and an electrolyte ionically coupling the cathode and the anode-interlayer component, wherein: the interlayer faces toward the cathode.
Clause 13. The lithium-ion battery of clause 12, wherein: the cathode comprises lithium iron phosphate (LFP), lithium nickel manganese cobalt oxide, lithium cobalt oxide, lithium nickel cobalt aluminum oxide, and/or lithium manganese oxide.
Clause 14. The lithium-ion battery of any of clauses 12 to 13, further comprising: a separator disposed between the interlayer and the cathode, wherein: the electrolyte comprises a liquid electrolyte infiltrating the separator.
Clause 15. The lithium-ion battery of any of clauses 12 to 14, wherein: the electrolyte comprises LiPF₆, lithium bis(trifluoromethanesulfonyl)imide (LiTFSI), and/or lithium bis(fluorosulfonyl)imide (LiFSI).
Clause 16. The lithium-ion battery of any of clauses 12 to 15, wherein: the current collector comprises Cu; and the anode comprises Li nuclei particles located between the current collector and the interlayer.
Clause 17. The lithium-ion battery of clause 16, wherein: at least some of the Li nuclei particles are fused together; and the anode comprises a porous layer comprising the fused Li nuclei particles.
Clause 18. The lithium-ion battery of clause 17, wherein: the porous layer has a thickness in a range of about 1 to about 12 μm.
Clause 19. The lithium-ion battery of any of clauses 12 to 18, wherein: the current collector comprises a Li metal layer; and the Li metal layer is free of dendrites after cycling of the lithium-ion battery.
Clause 20. A method, comprising: (A1) dealloying an Al—Li alloy in an alcohol to form a dispersion of Al alkoxide nanowires in a solvent comprising the alcohol; (A2) filtrating the Al alkoxide nanowires to remove the solvent; (A3) annealing the filtrated Al alkoxide nanowires to convert the filtrated Al alkoxide nanowires to Al₂O₃ nanowires; and (A4) carrying out a fluorination treatment to convert the Al₂O₃ nanowires to nanowires comprising aluminum fluoride (AlF₃).
Clause 21. The method of clause 20, wherein: the AlF₃ comprises α-phase AlF₃.
Clause 22. The method of any of clauses 20 to 21, wherein: the alcohol comprises methanol, ethanol, propanol, or butanol.
Clause 23. The method of any of clauses 20 to 22, wherein: the filtrating is carried out under vacuum.
Clause 24. The method of any of clauses 20 to 23, wherein: the annealing is carried out in a temperature range of about 300 to about 600° C.
Clause 25. The method of any of clauses 20 to 24, wherein: the fluorination treatment is carried out with a fluorinating gas selected from: nitrogen trifluoride (NF₃) gas, hydrogen fluoride (HF) gas, fluorine (F) gas, chlorine trifluoride (ClF₃) gas, sulfur hexafluoride (SF₆) gas, and chlorodifluoromethane (CHClF₂) gas.
Clause 26. The method of any of clauses 20 to 25, wherein: the filtrated Al alkoxide nanowires are in the form of a membrane upon removal of the solvent.
Clause 27. The method of clause 26, wherein: the membrane comprises the filtrated AlF₃-comprising nanowires upon completion of the annealing (A4).
Clause 28. The method of clause 27, wherein: the membrane is configured as an interlayer disposed on an anode; the anode comprises one or more of the following in direct contact with the interlayer: Li metal, a current collector, or composite particles comprising carbon and silicon; and the interlayer and the anode together constitute an anode-interlayer component.
Clause 29. The method of any of clauses 20 to 28, further comprising: (A5) making a slurry comprising the AlF₃-comprising nanowires; and (A6) dispensing the slurry on a substrate to form a coating comprising the AlF₃-comprising nanowires disposed on the substrate.
Clause 30. The method of clause 29, further comprising: carrying out milling on the AlF₃-comprising nanowires before making the slurry.
Clause 31. The method of any of clauses 29 to 30, wherein: the substrate comprises an anode; the coating is an interlayer comprising the AlF₃-comprising nanowires; the anode comprises one or more of the following in direct contact with the interlayer: Li metal, a current collector, or composite particles comprising carbon and silicon; and the interlayer and the anode together constitute an anode-interlayer component.

The description is provided to enable any person skilled in the art to make or use embodiments of the present invention. It will be appreciated, however, that the present invention is not limited to the particular formulations, process stages, and materials disclosed herein, as various modifications to these embodiments will be readily apparent to those skilled in the art. That is, the generic principles defined herein may be applied to other embodiments without departing from the spirit or scope of the invention.

What is claimed is:

1. A nanowire composition, comprising:
nanowires comprising aluminum fluoride (AlF₃).

2. The nanowire composition of claim 1, wherein:
the AlF₃ comprises α-phase AlF₃.

3. The nanowire composition of claim 1, wherein:
the nanowires are porous and comprise external pores.

4. The nanowire composition of claim 1, wherein:
an average diameter of the nanowires is in a range of about 100 to about 500 nm.

5. The nanowire composition of claim 1, wherein:
an average length of the nanowires is in a range of about 100 to about 1000 μm.

6. The nanowire composition of claim 1, wherein:
an average aspect ratio of the nanowires is in a range of about 1000 to 1×10⁴.

7. A membrane, comprising:
the nanowire composition of claim 1.

8. The membrane of claim 7, wherein:
the membrane comprises a nonwoven network of the nanowires.

9. An anode-interlayer component, comprising:
an anode; and
an interlayer disposed on the anode,
wherein:
the interlayer comprises the nanowire composition of claim 1; and
the interlayer is in the form of a membrane or a coating.

10. The anode-interlayer component of claim 9, wherein:
the anode comprises one or more of the following in direct contact with the interlayer: Li metal, a current collector, or composite particles comprising carbon and silicon.

11. The anode-interlayer component of claim 10, wherein:
the anode comprises the current collector; and
the current collector comprises Cu, Al, Ni, Ti, Mo, Fe, steel, a graphene coating, a carbon coating or film, carbon nanotubes, and/or carbon nanofibers.

12. A lithium-ion battery, comprising:
a cathode;
the anode-interlayer component of claim 10; and
an electrolyte ionically coupling the cathode and the anode-interlayer component,
wherein:
the interlayer faces toward the cathode.

13. The lithium-ion battery of claim 12, wherein:
the cathode comprises lithium iron phosphate (LFP), lithium nickel manganese cobalt oxide, lithium cobalt oxide, lithium nickel cobalt aluminum oxide, and/or lithium manganese oxide.

14. The lithium-ion battery of claim 12, further comprising:
a separator disposed between the interlayer and the cathode,
wherein:
the electrolyte comprises a liquid electrolyte infiltrating the separator.

15. The lithium-ion battery of claim 12, wherein:
the electrolyte comprises LiPF₆, lithium bis(trifluoromethanesulfonyl)imide (LiTFSI), and/or lithium bis(fluorosulfonyl)imide (LiFSI).

16. The lithium-ion battery of claim 12, wherein:
the current collector comprises Cu; and
the anode comprises Li nuclei particles located between the current collector and the interlayer.

17. The lithium-ion battery of claim 16, wherein:
at least some of the Li nuclei particles are fused together; and
the anode comprises a porous layer comprising the fused Li nuclei particles.

18. The lithium-ion battery of claim 17, wherein:
the porous layer has a thickness in a range of about 1 to about 12 μm.

19. The lithium-ion battery of claim 12, wherein:
the current collector comprises a Li metal layer; and
the Li metal layer is free of dendrites after cycling of the lithium-ion battery.

20. A method, comprising:
(A1) dealloying an Al—Li alloy in an alcohol to form a dispersion of Al alkoxide nanowires in a solvent comprising the alcohol;
(A2) filtrating the Al alkoxide nanowires to remove the solvent;
(A3) annealing the filtrated Al alkoxide nanowires to convert the filtrated Al alkoxide nanowires to Al₂O₃ nanowires; and
(A4) carrying out a fluorination treatment to convert the Al₂O₃ nanowires to nanowires comprising aluminum fluoride (AlF₃).

21. The method of claim 20, wherein:
the AlF₃ comprises α-phase AlF₃.

22. The method of claim 20, wherein:
the alcohol comprises methanol, ethanol, propanol, or butanol.

23. The method of claim 20, wherein:
the filtrating is carried out under vacuum.

24. The method of claim 20, wherein:
the annealing is carried out in a temperature range of about 300 to about 600° C.

25. The method of claim 20, wherein:
the fluorination treatment is carried out with a fluorinating gas selected from:
nitrogen trifluoride (NF₃) gas, hydrogen fluoride (HF) gas, fluorine (F₂) gas, chlorine trifluoride (ClF₃) gas, sulfur hexafluoride (SF₆) gas, and chlorodifluoromethane (CHClF₂) gas.

26. The method of claim 20, wherein:
the filtrated Al alkoxide nanowires are in the form of a membrane upon removal of the solvent.

27. The method of claim 26, wherein:
the membrane comprises the filtrated AlF₃-comprising nanowires upon completion of the annealing (A4).

28. The method of claim 27, wherein:
the membrane is configured as an interlayer disposed on an anode;
the anode comprises one or more of the following in direct contact with the interlayer: Li metal, a current collector, or composite particles comprising carbon and silicon; and
the interlayer and the anode together constitute an anode-interlayer component.

29. The method of claim 20, further comprising:
(A5) making a slurry comprising the AlF₃-comprising nanowires; and
(A6) dispensing the slurry on a substrate to form a coating comprising the AlF₃-comprising nanowires disposed on the substrate.

30. The method of claim 29, further comprising:
carrying out milling on the AlF₃-comprising nanowires before making the slurry.

31. The method of claim 29, wherein:
the substrate comprises an anode;
the coating is an interlayer comprising the AlF₃-comprising nanowires;
the anode comprises one or more of the following in direct contact with the interlayer: Li metal, a current collector, or composite particles comprising carbon and silicon; and
the interlayer and the anode together constitute an anode-interlayer component.
